(19) United States
(12) Patent Application Publication
(10) Pub. No.: US 2023/0345328 A1
(43) Pub. Date: Oct. 26, 2023

(54) SYSTEMS AND METHODS TO PRIORITIZE CELLS BASED ON RELAXED MEASUREMENT

(71) Applicant: SAMSUNG ELECTRONICS CO., LTD., Suwon-si (KR)

(72) Inventors: Nishant, Bangalore (IN); Gokul Keshav, Bangalore (IN); Vivek Murugaiyan, Bangalore (IN); Kailash Kumar Jha, Bangalore (IN)

(21) Appl. No.: 18/338,784

(22) Filed: Jun. 21, 2023

Related U.S. Application Data
(63) Continuation of application No. PCT/KR2023/003623, filed on Mar. 17, 2023.

(30) Foreign Application Priority Data
Mar. 22, 2022 (IN) 202241015669
Jan. 23, 2023 (IN) 202241015669

(51) Int. Cl. H04W 36/08; H04W 36/00; H04W 36/18

(52) U.S. Cl. CPC H04W 36/08; H04W 36/0058; H04W 36/00835; H04W 36/18

(57) ABSTRACT

The disclosure relates to systems and methods for prioritizing cells based on relaxed measurements during cell selection/reselection, redirection, mobility from EUTRA command, conditional handovers, and dual active protocol stack (DAPS) handovers. For example, the disclosure relates to facilitating UEs to prioritize NR cells that support relaxed measurements based on relaxedMeasurement-r16 IE broadcasted in SIB2 message during cell selection/reselection in RRC idle or inactive state and further during DAPS handover and conditional handover in RRC connected state.

### CROSS-REFERENCE TO RELATED APPLICATIONS

This application is a continuation of International Application No. PCT/KR2023/003623 designating the United States, filed on Mar. 17, 2023, in the Korean Intellectual Property Receiving Office and claiming priority to Indian Provisional Patent Application No. 202241015669, filed on Mar. 22, 2022, in the Indian Patent Office, and to Indian Complete Patent Application No. 202241015669, filed on Jan. 23, 2023, in the Indian Patent Office, the disclosures of all of which are incorporated by reference herein in their entireties.

### BACKGROUND

### Field

The disclosure relates to wireless communications, and for example, relates to a system and method for prioritizing cells based on relaxed measurements during cell selection/reselection, redirection, mobility from Evolved Universal Terrestrial Radio Access (EUTRA) to New Radio (NR), conditional handovers, and dual active protocol stack (DAPS) handovers.

### Description of Related Art

With technological advancements and multiple features introduced in mobile communication networks, the need for power consumption optimization and energy saving in mobile 5G devices has significantly increased. In fact, in any wireless communication system, power saving is one of the most important issue, and it becomes more important for mobile devices which have limited amount of power source. Further, apart from its ecological value, the goal of energy saving increases user experience by prolonging the battery life of the user equipment (UE).

Energy efficiency is important for both user equipment (UE) side and base station side. Trade-offs have to be carefully considered between energy efficiency and other performance aspects such as latency, throughput, connection densities and reliability. It is important that improvement in UE experience in performance aspects would not affect battery life of 5G handsets. Similarly, efficient network implementation is critical in both environmental and operation cost standpoints in the base station.

Currently, 5G New Radio (NR) standard is designed to have great flexibility on network operation mode to adapt to different traffic loads for better energy efficiency and various power saving techniques are deployed. For cell re-selection and handover processes, the UE utilizes considerable amount of energy during the process of neighbour cell measurement. Neighbour cell frequency measurement is inevitable for cell re-selection and handover procedures. Cell re-selection occurs in the UE in idle or inactive state, and the UE triggers neighbouring cell measurements in intra frequency, inter frequency and inter RAT when serving cell measurement reaches a threshold. Further, the neighbouring cell measurement occurs whenever serving cell measurement reaches a threshold, even when UE is not in low mobility state and not in cell edge condition.

One of the conventional solutions to improve power efficiency relates to reducing neighbouring cell measurements. A relaxedMeasurement-r16 IE has been introduced in release 16 NR specification, which provides information to aid in reducing the measurements performed by the UE. In this process, when the UE is camped on in a cell configured with relaxed measurement, the UE will relax the neighbour cell measurements in idle/inactive state based on configuration received in release 16 IEs in System Information Block2 (SIB2). The configuration information received in SIB2 contains the information related to lowMobilityEvaluation-r16 and cellEdgeEvaluation-r16 which facilitates in finding out whether the UE is in low mobility or not in cell edge, and so neighbour cell measurements will be relaxed when these conditions are met. The configuration also contains highPriorityMeasRelax-r16 which relaxes UE to measure high priority inter frequency measurement mandatorily in idle/inactive state. Based on the above process, the UE may save power and increases mobility performance of the UE, however, serving cell measurements shall be always measured in UE irrespective of relaxed measurement configurations.

The current processes of cell selection/re-selection, handover, conditional handover, and Dual Active Protocol Stack (DAPS) handovers under 5G NR are provided herein below.

Cell Selection: The initial cell selection process may happen with or without the prior knowledge of the NR frequency RF channels. When no prior knowledge is available, the UE scans all RF channels in the NR bands according to capability support for finding a suitable cell. Optionally, if the stored information is available on cell parameters/frequencies from previously received measurements or detected cells, the UE may choose a suitable cell once the same is found. According to 3GPP Specification TS 38.304 5.2.3.1, priorities of RAT and different frequencies given to the UE by System Information (SIB) or by dedicated signalling may not be used during this process.

Cell Reselection: When the UE is in IDLE or INACTIVE mode, it has information about different frequencies and its priorities. This information is used by the UE to reselect to a different cell based on the priority and signal conditions of the cell. The UE identifies all the candidate NR cell frequencies as per the reselection criteria defined in 3GPP Specification TS 38.304 and selects a suitable cell to complete the reselection process.

Handover: The UE transmits measurement reports, if the link to the serving cell is getting degraded and/or neighbouring cell is getting better than the serving cell based on the measurement report configuration. Based on these measurement reports, the network evaluates the mobile terminal conditions and may move the UE connection to the neighbouring cell by sending the target cell information in the RRC Reconfiguration message, and accordingly, the mobile terminal will get better radio conditions.

Redirection: The redirectedCarrierInfo in RRC Release message indicates a carrier frequency which is used to redirect the UE to a NR cell or an inter-RAT carrier frequency. In redirection, UE camps on the redirected frequency after the RRC release.

Mobility from E-UTRA Command: This is inter-RAT handover command for the handover from LTE to NR. The UE moves from LTE to NR cell based on this handover command.

Conditional Handover (CHO): The network configures the UE with one or more candidate target SpCells in the conditional reconfiguration which contains the information to perform handover for the respected candidate cells along with associated conditions to be monitored similar to the measurement information. The UE evaluates the condition of each configured candidate target SpCell and UE applies the conditional configuration associated with one of the target SpCells which fulfils associated execution condition and through which handover gets success. The conditional configuration information present in UE is used during cell selection for RRC Reestablishment when RLF or reconfiguration with sync failure occurs.

Dual Active Protocol Stack (DAPS) Handover: DAPS Handover is similar to conventional handover, where the network evaluates the UE conditions based on measurement reports received from the UE and may move the UE connection to the neighbouring cell by sending the target cell information in the RRC reconfiguration message. In DAPS HO, the UE does not release the source cell even after target cell gets configured and moves to target cell. The UE continues to receive data from the source cell in addition to sending and receiving data with the target cell. Specifically, the UE maintains the source cell connection and release the source cell only after source release indication is received from the network.

FIG. 1 is a schematic diagram illustrating a conventional measurement configuration for UEs without relaxed measurement configuration for cell selection/re-selection and handovers, according to the prior art. As depicted, a UE may be under serving under NR cell gNB 1 and may be configured to periodically measure inter/intra neighbouring NR cells as per 3 GPP standard, although the UE is in low-mobility or not-at-cell-edge. Thus, the UE may be configured to periodically measure inter/intra neighbouring NR cells gNB2 and gNB3, even though the UE is in low-mobility or not-at-cell-edge. Such continuous measurement degrades the battery life of the UE.

FIG. 2 is a schematic diagram illustrating conventional measurement configuration for UEs with relaxed measurement configuration for cell selection/re-selection and handovers, according to the prior art. In such conventional solution associated with relaxed measurement configuration, the UE does not perform periodic measurement in low-mobility/not-at-cell-edge cases. However, the UE performs periodic measurements in mobility/cell-edge cases.

FIGS. 3A and 3B are schematic diagrams illustrating a conventional measurement configuration for UEs with relaxed measurement configuration for cell selection/re-selection and handovers, according to the prior art. As depicted, the gNB1 may be the serving NR cell, while the neighbouring cells gNB2 may support relaxed measurement configuration and gNB3 may not support relaxed measurement configuration. Upon cell selection/reselection, the UE may select/reselect gNB3, and thus might not be able to perform relaxed measurements as depicted in FIG. 3B. Thus, although there is a presence of relaxed measurement supported NR cell gNB2, the UE may select/reselect/handover to gNB3 which does not support relaxed measurement, and thus, the UE may not be able to perform relaxed measurements. Due to the selection of gNB3, the UE may have a discarded chance of power consumption optimisation and low mobility performance.

In the aforementioned processes under 5G NR, there are further challenges that need to be addressed, as discussed herein below. For instance, during cell-reselection, the UE has to measure neighbouring cell signal conditions based on current serving cell signal strength. The UE may trigger intra frequency measurement and low priority inter frequency/inter rat measurement when serving cell strength reaches configured threshold, and performs high priority inter frequency/inter rat measurement irrespective of serving cell signal strength.

In 3GPP Release-16, relaxed measurement configuration is introduced which makes UE to relax measurements based on configuration and saves power in UE.

Accordingly, there is a need to address the above challenges to provide a more efficient manner of cell selection/reselection, redirection, mobility from EUTRA command and handover strategies in 5G NR. Further, there is a need to make the current methods more efficient for better chance of power consumption optimisation.

### SUMMARY

According to an example embodiment of the present disclosure, a method for initiating one of a cell selection and a handover for a User Equipment (UE) is disclosed. The method comprises: identifying, by the UE, a plurality of candidate cells for one of the cell selection and the handover for the UE; identifying, by the UE, at least one candidate cell from among the plurality of candidate cells that support relaxed measurement; and initiating, by the UE, one of the cell selection and the handover for the UE using the at least one candidate cell that support relaxed measurement.

According to an example embodiment of the present disclosure, a method for managing one of a cell selection and a handover for a User Equipment (UE) is disclosed. The method comprises: detecting that a signal strength of a UE connected with a first cell decreases below a specified threshold level; identifying a plurality of second cells having a signal strength above another specified threshold level; identifying at least one cell from among the plurality of second cells having a relaxed measurement capability; and initiating one of the cell selection and the handover for the UE using the at least one cell having the relaxed measurement capability for connecting to a network.

According to an example embodiment of the present disclosure, a method for initiating one of a cell selection and a handover for a User Equipment (UE) is disclosed. The method comprises: identifying, by the UE, a plurality of candidate cells for one of the cell selection and the handover for the UE; identifying, by the UE, at least one candidate cell from among the plurality of candidate cells that support relaxed measurement, and at least one other candidate cell from among the plurality of candidate cells that do not support relaxed measurement; determining whether a signal strength of the at least one other candidate cell is higher than the signal strength of the at least one candidate cell by a specified threshold; and initiating, by the UE, one of the cell selection and the handover for the UE based on the determination.

According to an example embodiment of the present disclosure, a system configured to initiate one of a cell selection and a handover for a User Equipment (UE) is disclosed. The system comprises: one or more processors configured to: identify, by the UE, a plurality of candidate cells for one of the cell selection and the handover for the UE; identify, by the UE, at least one candidate cell from among the plurality of candidate cells that support relaxed measurement; and initiate, by the UE, one of the cell selection and the handover for the UE using the at least one candidate cell that support relaxed measurement.

According to an example embodiment of the present disclosure, a system configured to manage one of a cell selection and a handover for a User Equipment (UE) is disclosed. The system comprises: one or more processors configured to: detect that a signal strength of a UE connected with a first cell decreases below a specified threshold level; identify a plurality of second cells having a signal strength above another specified threshold level; identify at least one cell from among the plurality of second cells having a relaxed measurement capability; and initiate one of the cell selection and the handover for the UE using the at least one cell having the relaxed measurement capability for connecting to a network.

According to an example embodiment of the present disclosure, a system configured to initiate one of a cell selection and a handover for a User Equipment (UE) is disclosed. The system comprises: one or more processors configured to: identify, by the UE, a plurality of candidate cells for one of the cell selection and the handover for the UE; identify, by the UE, at least one candidate cell from among the plurality of candidate cells that support relaxed measurement, and at least one other candidate cell from among the plurality of candidate cells that do not support relaxed measurement; determine whether a Reference Signal Received Power (RSRP) of the at least one other candidate cell is higher than the RSRP of the at least one candidate cell by a specified threshold; and initiate, by the UE, one of the cell selection and the handover for the UE based on the determination.

To further clarify various advantages and features of the present disclosure, a more particular description will be rendered by reference to various example embodiments thereof, which is illustrated in the appended drawings. It will be appreciated that these drawings merely depict example embodiments of the disclosure and are therefore not to be considered limiting of its scope. The disclosure will be described and explained with additional specificity and detail with reference to the accompanying drawings.

### BRIEF DESCRIPTION OF THE DRAWINGS

The above and other features, aspects, and advantages certain embodiments of the present disclosure will be more apparent from the following detailed description, taken in conjunction with the accompanying drawings in which like characters represent like parts throughout the drawings, an in which:

FIG. 1 is a diagram illustrating conventional measurement configuration for UEs without relaxed measurement configuration for cell selection/re-selection and handovers, according to the prior art;

FIG. 2 is a diagram illustrating conventional measurement configuration for UEs with relaxed measurement configuration for cell selection/re-selection and handovers, according to the prior art;

FIGS. 3A and 3B are diagrams illustrating conventional measurement configuration for UEs with relaxed measurement configuration for cell selection/re-selection and handovers, according to the prior art;

FIG. 4 is a diagram illustrating an example measurement configuration for UEs with relaxed measurement configuration for cell selection/re-selection and handovers, according to various embodiments;

FIG. 5 is a diagram illustrating an example SIB2 information element, according to various embodiments;

FIG. 6A is a flowchart illustrating a method for cell selection in 5G NR at a UE, according to the prior art;

FIG. 6B is a flowchart illustrating an example method for prioritizing cells based on relaxed measurements during cell selection, according to various embodiments;

FIG. 6C is a diagram illustrating an example of prioritizing cells based on relaxed measurements during cell selection, according to various embodiments;

FIG. 7A is a flowchart illustrating a method for cell re-selection in 5G NR at a UE, according to the prior art;

FIG. 7B is a flowchart illustrating an example method for prioritizing cells based on relaxed measurements during cell re-selection, according to various embodiments;

FIG. 7C is a diagram illustrating an example of prioritizing cells based on relaxed measurements during cell re-selection, according to various embodiments;

FIG. 8A is a flowchart illustrating a method for cell/DAPS handover in 5G NR, according to the prior art;

FIG. 8B is a flowchart illustrating an example method for prioritizing cells based on relaxed measurements during cell/DAPS handover, according to various embodiments;

FIGS. 8C and 8D include a diagram and a signal flow diagram respectively illustrating an example of prioritizing cells based on relaxed measurements during cell/DAPS, according to various embodiments;

FIG. 9A is a flowchart illustrating a method for conditional handover in 5G NR at a UE, according to the prior art;

FIG. 9B is a flowchart illustrating an example method for prioritizing cells based on relaxed measurements during conditional handover, according to various embodiments;

FIGS. 9C and 9D include a diagram and a signal flow diagram respectively illustrating an example of prioritizing cells based on relaxed measurements during conditional handover, according to various embodiments;

FIG. 10A is a flowchart illustrating a method for redirection in 5G NR at a UE, according to the prior art;

FIG. 10B is a flowchart illustrating an example method for prioritizing cells based on relaxed measurements during redirection, according to various embodiments;

FIGS. 10C and 10D include a diagram and a signal flow diagram respectively illustrating an example of prioritizing cells based on relaxed measurements during redirection, according to various embodiments;

FIG. 11A is a flowchart illustrating a method for Inter-RAT handover in 5G NR at a UE, according to the prior art;

FIG. 11B is a flowchart illustrating an example method for prioritizing cells based on relaxed measurements during Inter-RAT handover, according to various embodiments;

FIGS. 11C and 11D include a diagram and a signal flow diagram respectively illustrating an example of prioritizing cells based on relaxed measurements during Inter-RAT handover, according to various embodiments;

FIG. 12 is a flowchart illustrating an example method for initiating one of a cell selection and a handover for a User Equipment (UE), according to various embodiments;

FIG. 13 is a flowchart illustrating an example method for initiating one of a cell selection and a handover for a User Equipment (UE), according to various embodiments;

FIG. 14 is a flowchart illustrating an example method for initiating one of a cell selection and a handover for a User Equipment (UE), according to various embodiments; and

FIG. 15 is a block diagram illustrating an example configuration of a user equipment (UE) in a wireless communication system, according to various embodiments.

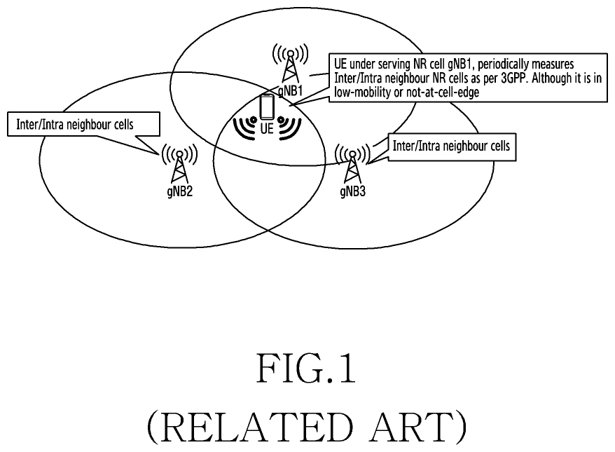

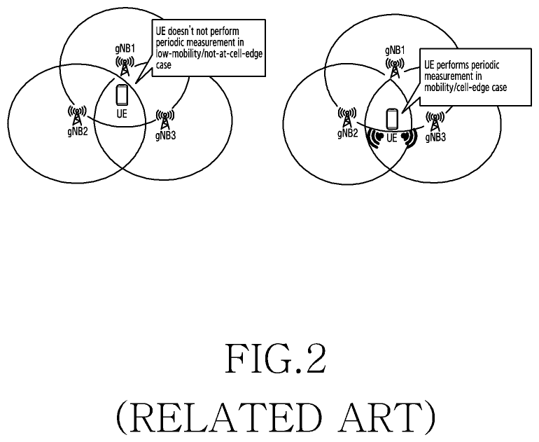

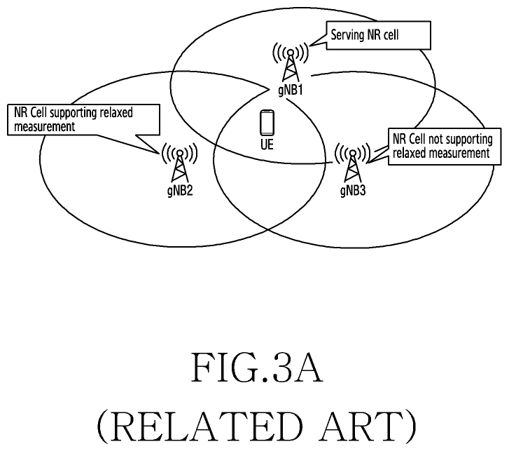

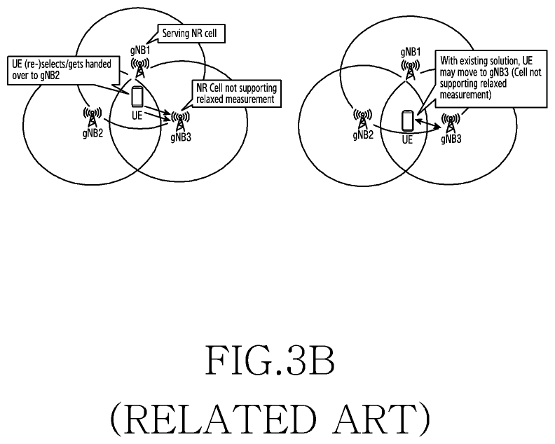

Further, skilled artisans will appreciate that elements in the drawings are illustrated for simplicity and may not have necessarily been drawn to scale. For example, the flowcharts illustrate various example methods in terms of operations involved to help to improve understanding of aspects of the present disclosure. Furthermore, in terms of the construction of the device, one or more components of the device may have been represented in the drawings by conventional symbols, and the drawings may show merely those specific details that are pertinent to understanding the disclosure and so as not to obscure the drawings with details that will be readily apparent to those of ordinary skill in the art having the benefit of the description herein.

### DETAILED DESCRIPTION

Reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with the embodiment being included in at least one example embodiment of the present disclosure. Thus, appearances of the phrase “in an embodiment”, “in another embodiment” and similar language throughout this disclosure may, but do not necessarily, all refer to the same embodiment.

The terms “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

In the conventional solutions as discussed above, during cell selection/reselection process, the UE may find list of suitable cells based on MRU scan or full band scan. Further, the UE camps on to the cell without considering relaxed measurement configuration. Also, in conditional handover, the UE will perform measurements for candidate cells configured in condition reconfiguration. Subsequently, the UE will perform handover with candidate cells that satisfy the condition configured in reconfiguration and moves to cell based on RSRP/RSRQ/SINR without considering relaxed measurement configuration. For DAPS handover, the UE performs measurement based on measurement configuration received from network. The UE reports all the cells that satisfies the measurement conditions. Accordingly, the UE does not consider relaxed measurement IE of neighbouring cells when the UE is moving from serving cell to another cell. So even in network condition of possibility for UE to move to cell with relaxed measurements, the UE is neglecting the opportunity and choosing other cells.

Thus, currently, there is no preference or cell prioritization defined during cell selection/reselection, conditional handover or redirection to NR based on relaxed measurements. It is up to UE implementation that which cell it needs to select from the list of available cells in the environment. Even during DAPS handover and Mobility from EUTRA command (to NR), the network configures UE with target cell based on measurement reports sent by UE to network.

The present disclosure relates to systems and methods for prioritizing cells based on relaxed measurements during cell selection/reselection, redirection, mobility from EUTRA command, conditional handovers, and dual active protocol stack (DAPS) handovers. For example, the disclosure relates to facilitating UEs to prioritize NR cells that supports relaxed measurements based on relaxedMeasurement-r16 IE broadcasted in SIB2 message during cell selection/reselection in RRC idle or inactive state and further during DAPS handover and conditional handover in RRC connected state.

Further, the present disclosure facilitates UEs to prioritize NR cells that support relaxed measurements based on relaxedMeasurement-r16 IE broadcasted in SIB2 message during cell selection/reselection in RRC idle or inactive state and during DAPS handover and conditional handover in RRC Connected state. Additionally, the disclosure relates to the UE selecting relaxed measurement supported NR cell(s) whenever possible thereby conserving battery life and improving UE mobility performance.

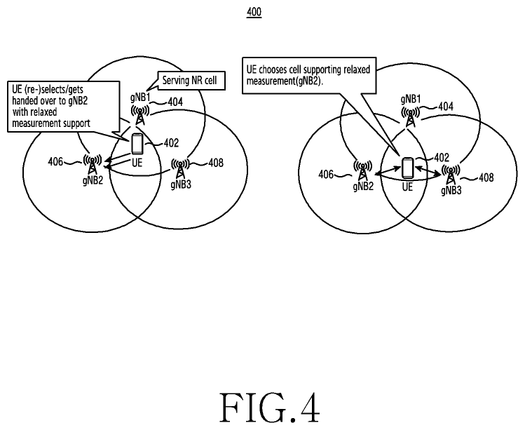

FIG. 4 is a diagram 400 illustrating an example measurement configuration for UEs with relaxed measurement configuration for cell selection, according to various embodiments. As illustrated, a UE 402 may be under serving under NR cell gNB1 404 and may be configured to periodically measure inter/intra neighbouring NR cells 406, 408 as per 3GPP standard. In accordance with an embodiment of the present disclosure, the UE 402 movement during cell selection/reselection/handover is prioritized to a relaxed measurement supported cell. The UE 402 may be configured to analyze SIB2 of suitable cells 406, 408 found during measurement, and prioritize the cell(s) gNB2 406 configured with relaxed measurement information element (IE). Thus, the UE 402 camps on to the particular cell 406 having such relaxed measurement IE before camping on to other suitable cells.

According to an embodiment related to conditional handover, the UE 402 performs measurement for the candidate cells 406, 408 configured in condition reconfiguration, and the UE 402 will perform handover with candidate cell 406 that satisfy the condition configured in reconfiguration. For example, the disclosure includes analysis of SIB2 of candidate cells 406, 408 by the UE 402, that satisfy the CHO condition and prioritize the candidate cell 406 configured with relaxed measurement IE for performing handover on to that particular cell.

For conventional handover/DAPS handover, the UE 402 performs measurement based on measurement configuration received from network and reports the cell 406 that satisfies the measurement condition in measurement condition. According to an embodiment related to DAPS/conventional handover, the UE 402 may be configured to read and analyze SIB2 of cells that satisfy the measurement condition and report only the cell 406 configured with relaxed measurement IE, which provide high opportunity for network with RRC reconfiguration of cell with relaxed measurement for handover.

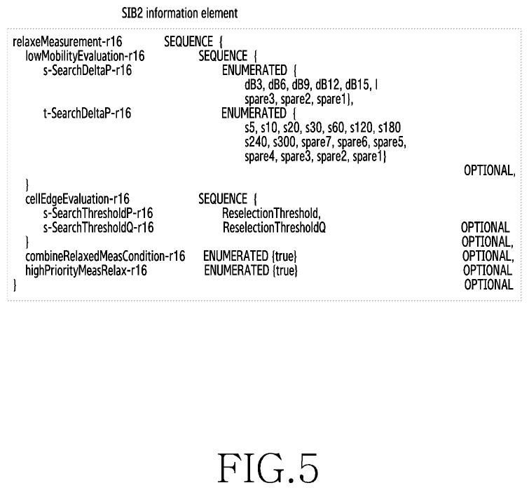

FIG. 5 illustrates an example SIB2 information element (IE) 500, according to various embodiments. According to an embodiment, the UE 402 may be configured to evaluate one or more parameters for cell selection/reselection/handover based on SIB2 IEs. The SIB2 may include an IE to evaluate whether the UE is in low mobility, an IE to evaluate whether the UE is not in the cell edge, and an IE to skip high priority inter frequency measurement. The SIB2 information element (IE) discussed herein is similar to the SIB2 IE in 3GPP TS 38.331.

The information fields within the SIB2 and their associated description is provided herein below:

TABLE 1

| Information Field | Description |
|---|---|
| lowMobilityEvaluation | Indicates the criteria for a UE to |
| | detect low mobility, in order to relax |
| | measurement requirements for cell |
| | reselection |
| highPriorityMeasRelax | Indicates whether measurements can be |
| | relaxed on high priority frequencies. |
| cellEdgeEvaluation | Indicates the criteria for a UE to |
| | detect that it is not at cell edge, in |
| | order to relax measurement |
| | requirements for cell reselection. |
| combineRelaxedMeasCondition | When both lowMobilityEvalutation and |
| | cellEdgeEvalutation criteria are present |
| | in SIB2, this parameter configures the |
| | UE to fulfil both criteria in order to |
| | relax measurement requirements for cell |
| | reselection. If the field is absent, the |
| | UE is allowed to relax measurement |
| | requirements for cell reselection when |
| | either or both of the criteria are met. |
| SsearchDeltaP | Specifies the threshold (in dB) on |
| | Srxlev variation for relaxed |
| | measurement |
| TsearchDeltaP | specifies the time period over which the |
| | Srxlev variation is evaluated for relaxed |
| | measurement |
| SsearchThresholdP | Specifies the Srxlev threshold (in dB) |
| | for relaxed measurement. |
| SsearchThresholdQ | Specifies the Squal threshold (in dB) |
| | for relaxed measurement |

In an embodiment, when the UE 402 is camped on in cell configured with relaxed measurement, the UE 402 may relax the neighbour cell measurements in idle/inactive state based on configuration received in release 16 IEs in SIB2. Further, the configuration received in SIB2 contains the information lowMobilityEvaluation-r16 and cellEdgeEvaluation-r16, which helps to determine whether the UE 402 is in low mobility or not in cell edge, and hence, neighbouring cell measurements may be relaxed when these conditions are met. Additionally, the configuration received in SIB2 contains highPriorityMeasRelax-r16, which helps in relaxing UE 402 to measure high priority inter frequency measurement mandatorily in idle/inactive state.

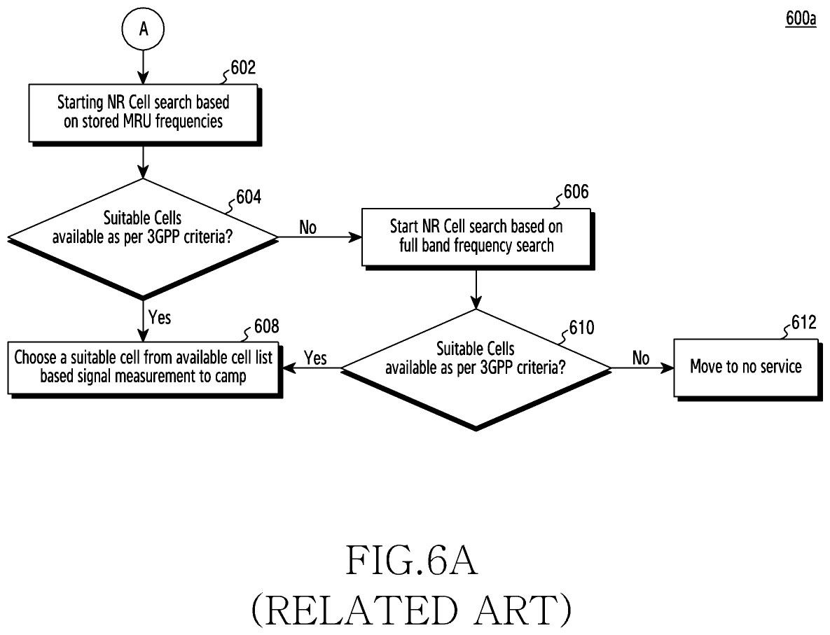

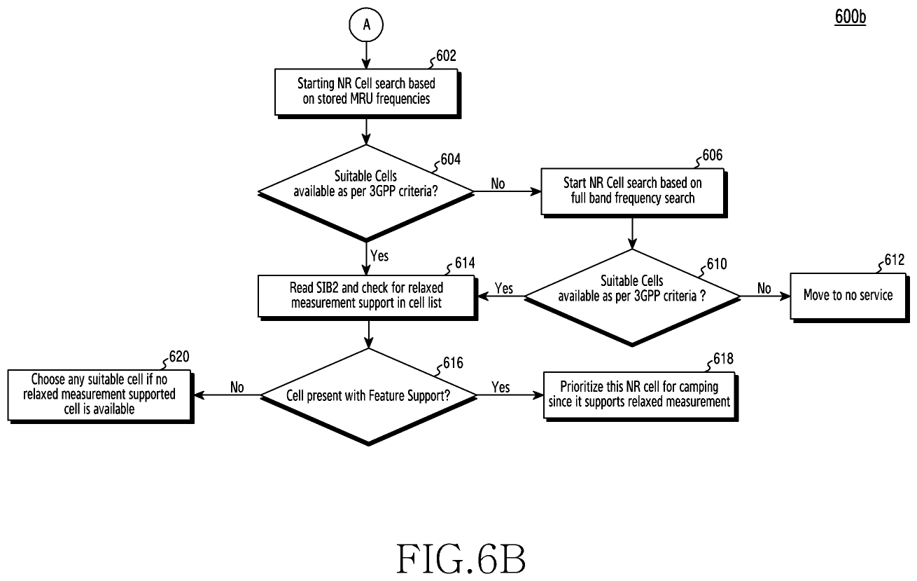

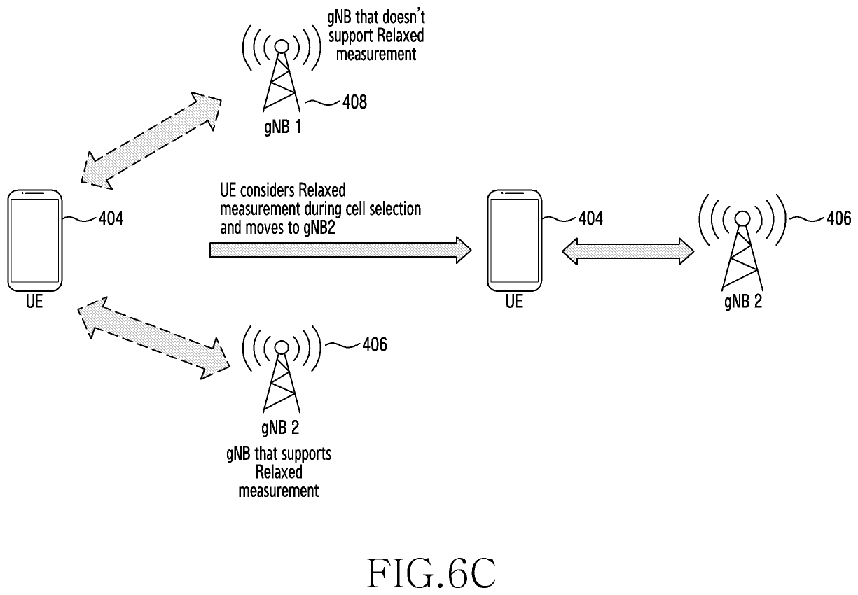

FIG. 6A is a flowchart illustrating a method 600a for cell selection in 5G NR at a UE, according to prior art. As depicted, at 602, the method 600a comprises starting, by the UE, the NR cell search based on one or more stored MRU frequencies. At 604, the method comprises determining whether one or more suitable cells are found as per 3GPP criteria. Determining whether one or more suitable cells are found may be performed based on RSRP and/or RSRQ value. Further, the cell suitability check may be performed in accordance with 3GPP specification section 5.2.3.2 of TS 38.304. If one or more suitable cells are found, a suitable cell may be selected for camping by the UE at step 608 of the method 600a. If suitable cells are not found as per 3GPP criteria, the NR cells are searched based on full band frequency search at 606 of the method 600a. At 610, the method comprises determining whether one or more suitable cells are available as per 3GPP criteria. If yes, then the method 600a moves to 608 to choose a suitable cell from the found one or more suitable cells in the full band frequency search. If no cells are found by either of the two methods, the UE may be moved to no service at 612.

FIG. 6B is a flowchart illustrating an example method 600b for prioritizing cells based on relaxed measurements during cell selection, according to various embodiments. FIG. 6C is a diagram illustrating an example of prioritizing cells based on relaxed measurements during cell selection, according to various embodiments. The method 600b includes operations 602-606, 610, and 612 similar to the corresponding operations in method 600a. According to an embodiment of the present disclosure, even after suitable cells are found as per 3GPP criteria at 604 of the method 600b, a further operations comprising reading and analysis of SIB2 may be performed by the UE for relaxed measurement support in the cell list at 614. At 616, the method 600b comprises determining whether one or more cells support the relaxed measurement feature. If a cell is found with relaxed measurement support, at 618, the method 600b comprises prioritizing the NR cell with relaxed measurement support for cell selection. If no NR cell with relaxed measurement support is found, then at 620, the method 600b comprises choosing any other suitable cell.

Referring to FIG. 6C, the UE 404 may search for stored frequencies associated with NR cells 406 and 408. While the NR cell 406 supports relaxed measurement, the NR cell 408 does not support relaxed measurement. Based on the method 600b as illustrated in FIG. 6B, the UE 404 completes cell selection with NR cell 406 that supports relaxed measurement. As result, it is able to use this feature for saving power.

For example, during cell selection procedure, if more than one cell is detected as a suitable cell, then UE 404 will prioritize the camping on the release-16 relaxed measurement feature supported cell, e.g., NR cell 406. After checking the cell suitability criteria, the UE 404 may read the SIB2 of the all the suitable cells to check the support of release-16 relaxed measurement feature. Based on the SIB2 information, the UE 404 may identify which all cells support release-16 relaxed measurement feature. For camping, the UE 404 may prioritize the cell which supports relaxed measurement feature. For example, the UE 404 may find two suitable cells, gNb1 408 and gNB2 406 in the environment. While gNB1 408 does not support Release-16 Relaxed measurement feature, whereas gNB2 406 may support release-16 relaxed measurement. The UE 404 may read the SIB2 of gNB1 408 and gNB2 406 and identify in which cell, relaxed measurement is supported. Based on determination, the UE 404 may prioritize camping on to gNB2 406. Hence, the UE 404 will consume lesser power in gNB2 406 due to release-16 relaxed measurement feature support in gNB2 406.

In another example embodiment, the UE 404 may be powered ON and perform cell search on the supported NR bands/frequencies. For example, UE 404 may find 4 NR cells (gNB1, gNB2, gNB3, gNB4) in the scan result. Out of 4 cells, 2 cells (gNB1 and gNB2) may be suitable for cell selection. Other 2 cells (gNB3 and gNB4) may not be suitable for camping. So, the UE 404 needs to choose between gNB1 and gNB2 for camping. Table 2 illustrates the detected cells along with the signal level and whether it is suitable or not during the cell selection procedure:

TABLE 2

| Cells Detected | Signal Level | | Is Suitable? |
|---|---|---|---|
| gNB1 | −85 | dBm | Suitable |
| gNB2 | −89 | dBm | Suitable |
| gNB3 | −110 | dBm | Not Suitable |
| gNB4 | −114 | dBm | Not Suitable |

In conventional solutions, the UE 404 may check for the signal strength and observes that gNB1's signal strength is −85 dBm, while gNB2's signal strength is −89 dBm. The UE 404 may select gNB1 and performs camping on this cell. However, according to the present disclosure, in addition to signal strength, the UE 404 may read SIB2 to identify the support of relaxed measurement feature, as illustrated in Table 3.

TABLE 3

| Cells Detected | Signal Level | | Is Suitable? | Relax Meas. |
|---|---|---|---|---|
| gNB2 | −89 | dBm | Suitable | Supported |
| gNB1 | −85 | dBm | Suitable | Not Supported |
| gNB3 | −110 | dBm | Not Suitable | Supported |
| gNB4 | −114 | dBm | Not Suitable | Not Supported |

Since the gNB2 may support the feature, whereas gNB1 doesn't support the feature. Accordingly, the UE 404 may initiate camping on gNB2 as it supports relaxed measurement though its signal strength is slightly less than gNB1.

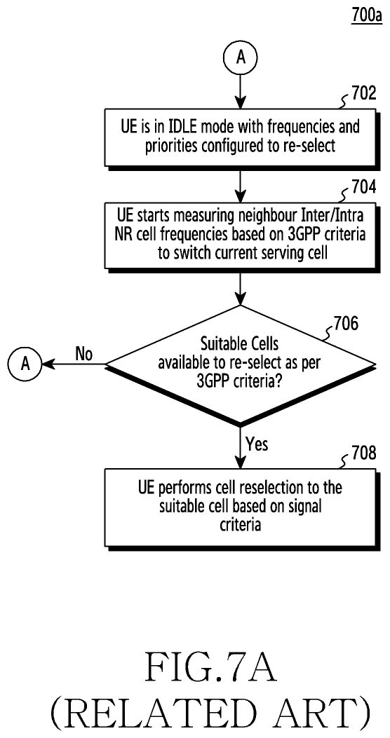

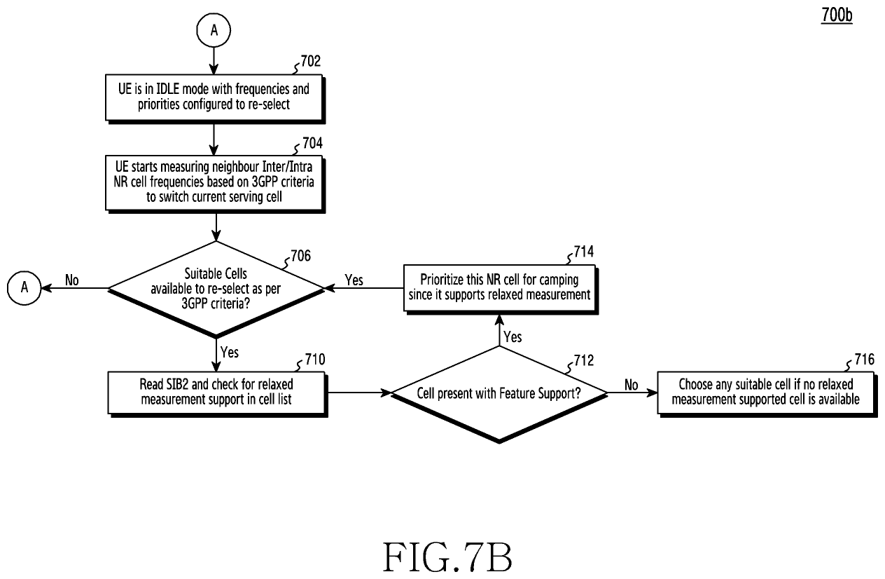

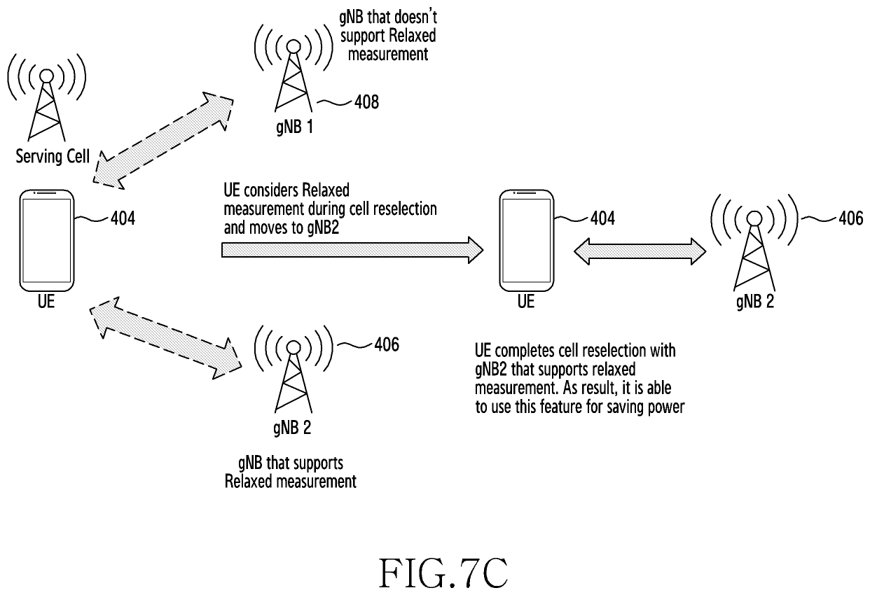

FIG. 7A is a flowchart illustrating a method 700a for cell re-selection in 5G NR at a UE, according to the prior art. As illustrated, at 702, the method 700a comprises the UE 404 in IDLE mode with frequencies and priorities configured to re-select. Subsequently, at 704, the method 700a comprises starting measuring, by the UE 404, neighbour Inter/Intra NR cell frequencies based on 3GPP criteria to switch the current serving cell. At 706, the method comprises determining whether one or more suitable cells are found as per 3GPP criteria. If one or more suitable cells are found, a suitable cell may be selected for re-selection by the UE at 708 of the method 700a. If no suitable cells are found, the method 700a may be moved back to 702.

FIG. 7B is a flowchart illustrating an example method 700b for prioritizing cells based on relaxed measurements during cell re-selection, according to various embodiments. FIG. 7C is a diagram illustrating an example of prioritizing cells based on relaxed measurements during cell selection, according to various embodiments. The method 700b includes operations 702-706 similar to the corresponding operations in method 700a. According to an embodiment of the present disclosure, even after suitable cells are found as per 3GPP criteria, a further operations comprising reading and analysis of SIB2 may be performed by the UE for relaxed measurement support in the cell list at 710. At 712, the method 700b comprises determining whether one or more cells support the relaxed measurement feature. If a cell is found with relaxed measurement support, then that specific NR cell may be prioritized for cell selection at 714. If no NR cell with relaxed measurement support is found, at 716, the method 700b comprises choosing any other suitable cell.

Referring to FIG. 7C, the UE 404 may perform neighbour cell measurement in idle mode to perform cell reselection. For cell reselection, UE measures neighbour cell to evaluate the reselection criteria. According to an embodiment, whenever there are more than one neighbour cells satisfying the cell reselection criteria, then the UE 404 may prioritize the reselection to the release-16 relaxed measurement feature supported cell. After evaluation of cell reselection condition, the UE 404 may read the SIB2 of the all the neighbour cells satisfying the reselection criteria to check the support of release-16 relaxed measurement feature. Based on the SIB2 information, the UE 404 may identify which all cells support release-16 relaxed measurement feature. So, for reselection, the UE 404 may prioritize the cell which supports relaxed measurement feature. Accordingly, the UE 404 may reselect the cell, where it will consume lower power.

In an example embodiment, if the UE 404 found 2 neighbour cells—gNb1 408 and gNB2 406 in the environment that satisfy the cell reselection criteria. gNB1 408 does not support Release-16 Relaxed measurement feature, whereas gNB2 406 may support release-16 relaxed measurement. According to an embodiment, the UE 404 may read the SIB2 of gNB1 408 and gNB2 406 and identify in which cell relaxed measurement is supported. Based on this determination, the UE 404 may prioritize reselection to gNB2 406. Hence, the UE 404 will consume lesser power in gNB2 406 due to release-16 relaxed measurement feature support in gNB2.

In an embodiment, in order to avoid ping pong as reselection would not be on best level cell, an additional 5 dB threshold will be considered by the UE 404 which performs the reselection using relaxed measurement IE. This would ensure that UE will be able to avail the power saving measures using release-16 relax measurement whenever possible.

In an example embodiment, the UE 404 may measure neighbour cells for cell reselection based on configured frequencies and priorities. For example, UE 404 may find 4 NR cells (gNB1, gNB2, gNB3, gNB4) in the scan result. Out of 4 cells, 2 cells (gNB1 and gNB2) may be suitable for cell selection, as illustrated previously in Table 2. In conventional solutions, the UE 404 may check for the signal strength and observe that gNB1 is −85 dBm, while gNB2 is −89 dBm. The UE 404 may reselect gNB1 for cell reselection.

However, according to various embodiments of the present disclosure, in addition to the signal strength, the UE may read SIB2 of satisfied neighbour cells to identify the support of relaxed measurement feature. Here, gNB2 supports the feature, whereas gNB1 doesn't support the feature as illustrated in Table 4 below:

TABLE 4

| | | | Cell reselection | |
|---|---|---|---|---|
| Cells Detected | Signal Level | | Criteria? | Relax Meas. |
| gNB2 | 89 | dBm | Satisfied | Supported |
| gNB1 | −85 | dBm | Satisfied | Not Supported |
| gNB3 | −110 | dBm | Not Satisfied | Supported |
| gNB4 | −114 | dBm | Not Satisfied | Not Supported |

As indicated, the UE 404 may perform reselection on gNB2 as it supports relaxed measurement though its signal strength is slightly less than gNB1. In an embodiment where multiple neighbour cells support relaxed measurement, then the UE may prioritize cells that have a better RSRP and better bandwidth than other cells. This ensures that the UE selects best suitable cell even among multiple relaxed measurement supported cells.

In an embodiment where a UE has found two suitable cells, e.g., a cell with relaxed measurement support and another cell without relaxed measurement, a threshold may be formulated to compare relaxed measurement supported cell with the other cells that are better in signal strength comparison.

The formulated threshold would help to prioritize cells based on both relaxed measurement support and signal strength conditions. As a result, unnecessary Radio Link Failure (RLF), Ping-Pong effects could be avoided.

For example, the formula may reside on the criteria that the RSRP of cell that does not support relaxed measurement should be better than by 10% as compared to the RSRP of the relaxed measurement supported cell for UE to choose this cell over relaxed measurement supported cell.

An example formula for choosing a cell may be defined as:

Cell to Choose=Maximum((gNB2 RSRP−(−156)+Threshold),(gNB3 RSRP−(−156)))

Threshold=0.1(RSRP of gNB2−(−156))

Note: The value −156 is taken to convert RSRP to positive value as it is the lowest RSRP value reported in NR
An example calculation of choosing between two such suitable cells is provided below in Table 5:

TABLE 5

| | Relaxed | | |
|---|---|---|---|
| Cell | Measurement support | RSRP | Converted RSRP |
| gNB2 | Supported | −100 | (−100 − (−156)) + 0.1 |
| | | | (−100 − (−156)) = 62 |
| gNB3 | Not Supported | −92 | (−92 − (−156)) = 64 |

UE prefers gNB3, e.g., cell without relaxed measurement based on RSRP comparison after threshold addition

Another example is illustrated below in Table 6 below:

TABLE 6

| | Relaxed | | |
|---|---|---|---|
| Cell | Measurement support | RSRP | Converted RSRP |
| gNB2 | Supported | −70 | (−70 − (−156)) + 0.1 |
| | | | (−70 − (−156)) = 95 |
| gNB3 | Not Supported | −62 | (−62 − (−156)) = 94 |

UE prefers gNB2, cell with relaxed measurement based on RSRP comparison after threshold addition

Based on this criteria during poor signal conditions, the threshold difference value will be low and during good signal conditions, the threshold value is high (Refer Ex). With this approach, the relaxed measurement supported cell will be given more preference during good signal conditions and during poor signal conditions, cells with better signal strength are given higher preference. This results in achieving a balance between relaxed measurement feature supported cells and good signal cells. The above approach of choosing a cell among two or more suitable cells may be followed for various cell selection, reselection, and handover examples discussed throughout the disclosure.

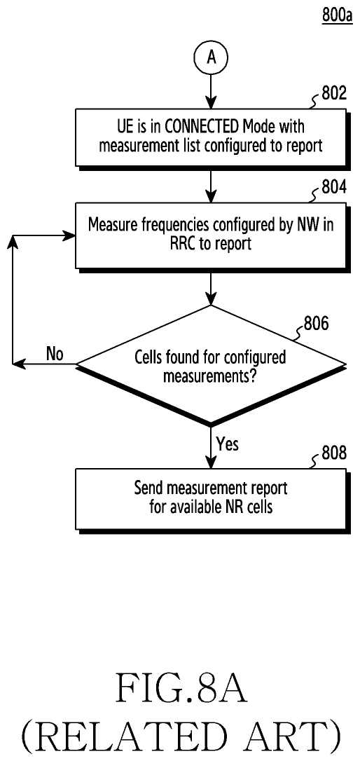

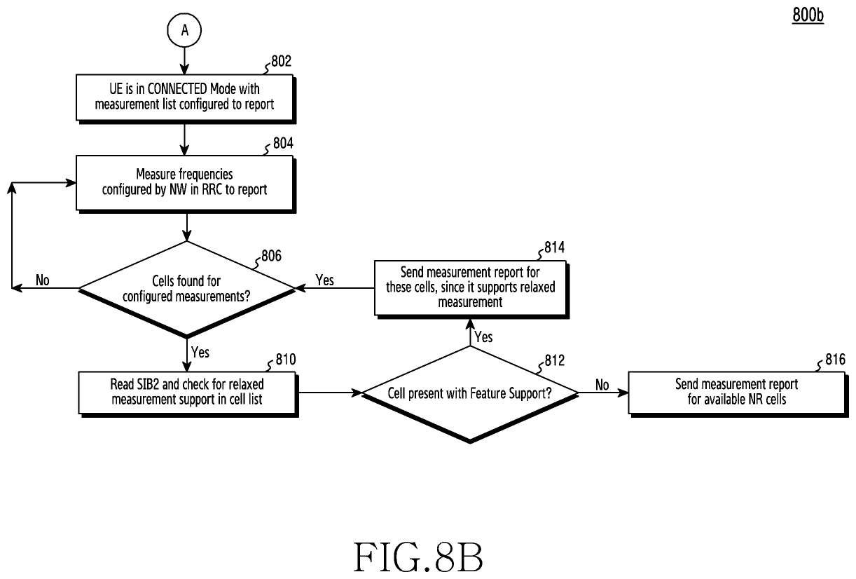

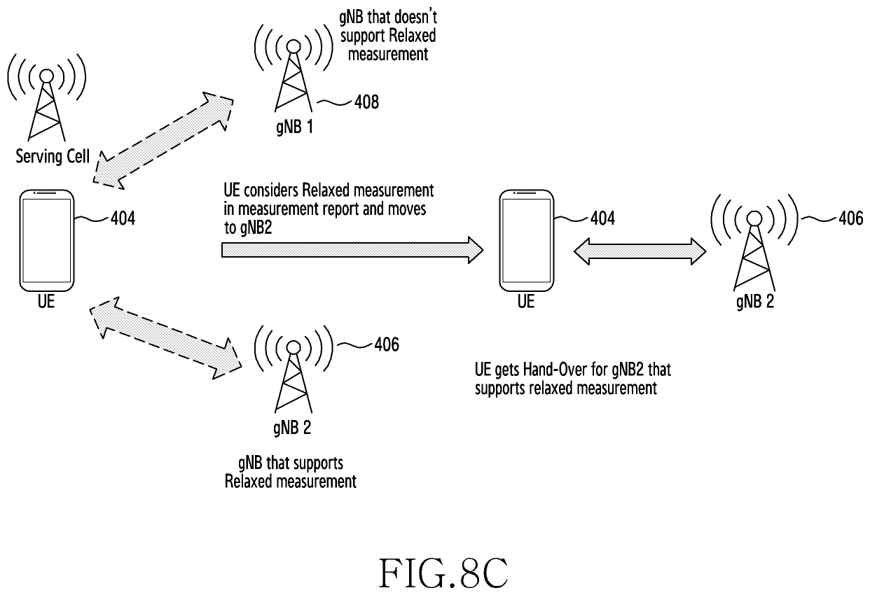

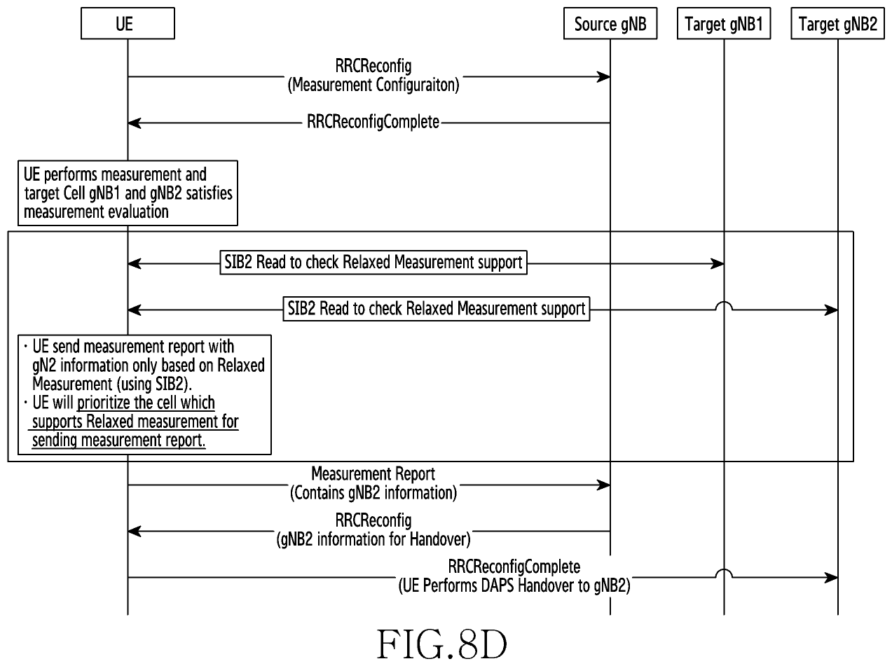

FIG. 8A is a flowchart illustrating a method 800a for cell/DAPS handover in 5G NR, according to the prior art. As illustrated, at 802, the method 800a comprises the UE 404 in CONNECTED Mode with measurement list configured to report. At 804, the method 800a comprises measuring frequencies, by the UE 404, as configured by the network in radio resource control (RRC) messages for reporting purpose. At 806, the method 800a comprises determining whether one or more suitable cells for configured measurements are found as per 3GPP criteria. If one or more suitable cells are found for configured measurements, then the UE may be configured to send measurement report(s) for available NR cells at 808 of the method 800a. If no suitable cells are found, the method 800a may be moved back to 802.

FIG. 8B is a flowchart illustrating an example method 800b for prioritizing cells based on relaxed measurements during cell/DAPS handover, according to various embodiments. FIGS. 8C and 8D include a diagram and a signal flow diagram respectively illustrating an example of prioritizing cells based on relaxed measurements during cell/DAPS handover, according to various embodiments. The method 800b includes operations 802-806 similar to the corresponding operations in method 800a. According to an embodiment of the present disclosure, even after suitable cells are found for configured measurements, as per 3GPP criteria, a further operation 810 comprising reading and analysis of SIB2 may be performed by the UE 404 for relaxed measurement support in the cell(s). At 812, the method 800b comprises determining whether one or more cells support the relaxed measurement feature. If a cell is found with relaxed measurement support, then the UE 404 may be configured to send measurement report(s) only for such NR cells at 814 of the method 800b. If no NR cell with relaxed measurement support is found, then at 816, the method 800b comprises sending measurement report for all NR cells.

Referring to FIG. 8C, the UE 404 may be in NR RRC connected mode and the network may have configured UE 404 with measurement objects for sending measurement report. The UE 404 may be configured to measure the configured measurement objects to send the measurement report based on meeting of criteria of configured events (e.g., event A3 or A5) for handover. For instance, event A3 may be triggered when a neighbouring cell becomes better than the serving cell by an offset value configured by the network. Event A5 may be triggered when the serving cell becomes worse than a first threshold and neighbouring cell becomes better than a second threshold configured by the network. Such events are defined in 3GPP specification TS 38.331. According to an embodiment, whenever there are more than one neighbour cells satisfying the A3 or A5 event criteria for handover, then UE 404 may prioritize sending the report containing the release-16 relaxed measurement feature supported cell. Specifically, after evaluation of A3/A5 event condition, the UE 404 may read the SIB2 of the all the neighbour cells (406 and 408) satisfying the event criteria to check the support of release-16 relaxed measurement feature. Based on the SIB2 information, the UE 404 may identify which all cells support release-16 relaxed measurement feature (e.g., 406). So, for handover, the UE 404 may prioritize relaxed measurement supported cell in measurement report. As a result, the network will configure UE 404 with cell 406 that supports relaxed measurement as target cell. This will increase the chance of getting handover to desired cell for lower power consumption. So, in the new target cell if UE moves to IDLE state after connection, UE will be able to avail relaxed measurement feature for power saving. This would ensure that UE will be able to avail the power saving measures using release-16 relax measurement whenever possible.

Referring to FIG. 8D, the UE may receive RRC configuration message from the source gNB to which it is currently connected and may further send a RRC Reconfiguration Complete message back to source gNB. Further, the UE may perform measurement and send measurement report only for gNB2 which supports relaxed measurement. The handover shall be completed based on RRC configuration messages exchanged between the source gNB and the UE. The UE may perform DAPS handover to gNB2 which supports relaxed measurement.

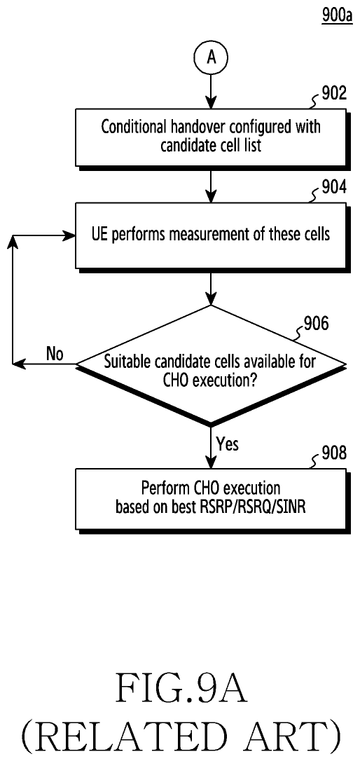

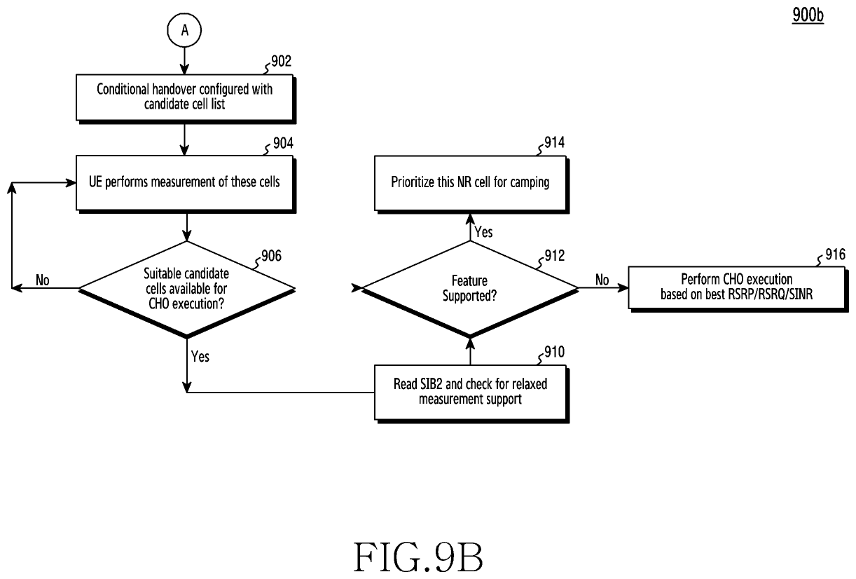

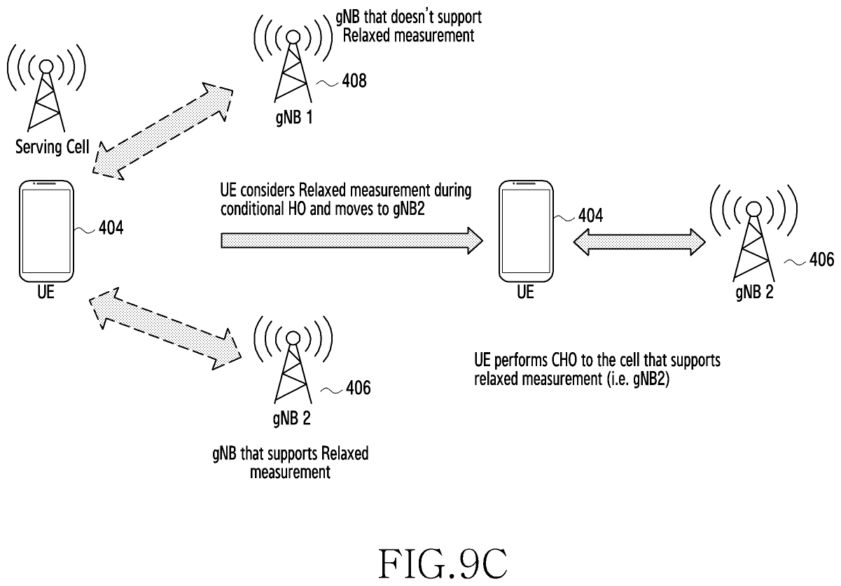

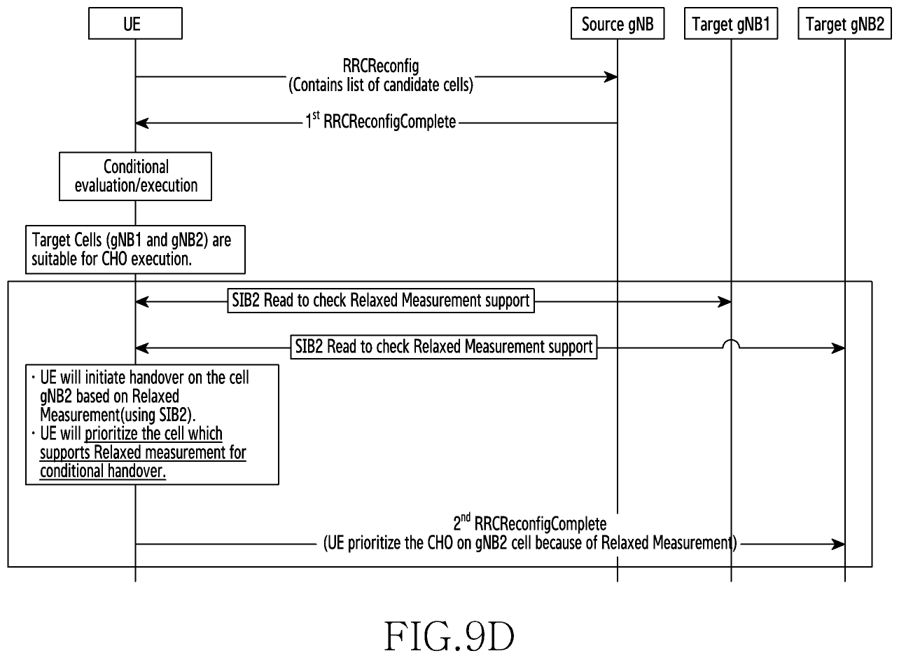

FIG. 9A is a flowchart illustrating a method 900a for conditional handover in 5G NR at a UE, according to the prior art. As depicted, at 902, the release-16 conditional handover may be configured with candidate cell list. At 904, the method 900a comprises performing measurement, by the UE, of these cells associated with the candidate cell list. At 906, the method comprises determining whether one or more suitable cells are found for conditional handover as per 3GPP criteria. If one or more suitable candidate cells are available for CHO execution, then the CHO execution may be performed based on best RSRP/RSRQ/SINR at 908.

FIG. 9B is a flowchart illustrating an example method 900b for prioritizing cells based on relaxed measurements during conditional handover, according to various embodiments. FIGS. 9C and 9D include a diagram and a signal flow diagram respectively illustrating an example of prioritizing cells based on relaxed measurements during conditional handover, according to various embodiments. The method 900b includes operations 902-906 similar to the corresponding operations in method 900a. According to an embodiment of the present disclosure, even after suitable cells are found for CHO execution, a further operation 910 comprising reading and analysis of SIB2 may be performed by the UE for relaxed measurement support in the cell(s). At 912, the method 900b comprises determining whether one or more cells support the relaxed measurement feature. If a cell is found with relaxed measurement support, then the UE 404 may be configured to prioritize such cell for camping at 914. Otherwise, the CHO execution may be performed based on best RSRP/RSRQ/SINR at 916.

Referring to FIG. 9C, the UE 404 may be in NR RRC connected mode and the network may have configured UE 404 with measurement objects for conditional handover. The UE 404 may be configured to measure the candidate cells and evaluates the condition reconfiguration of these cells. According to an embodiment, during conditional handover, when the network configures a list of candidate cells, then the UE 404 may prioritize the execution of the conditional handover on the release-16 relaxed measurement feature supported cell. After evaluation of condition reconfiguration, the UE 404 may read the SIB2 of the all the candidate cells satisfying the criteria to check the support of release-16 relaxed measurement feature. Based on the SIB2 information, the UE 404 may identify which all cells support release-16 relaxed measurement feature. So, for conditional handover, the UE 404 may prioritize relaxed measurement supported cell for condition execution. As a result, the UE 404 may move to the relaxed measurement target cell during conditional handover situation. For example, during the evaluation, 2 candidate cells may satisfy the condition simultaneously—gNb 1 408 and gNB2 406. The gNB1 408 may not support Release-16 Relaxed measurement feature, whereas the gNB2 406 may support release-16 relaxed measurement. In the current embodiment, the UE 404 may read the SIB2 of gNB1 408 and gNB2 406 and identify in which cell relaxed measurement is supported. Based on this determination, the UE 404 may execute the conditional handover to gNB2 406. So, in the new target cell, if the UE 404 moves to IDLE state after connection, the UE 404 will be able to avail relaxed measurement feature for power saving.

Referring to FIG. 9D, the UE may receive RRC Reconfiguration message from the source gNB to which it is currently connected. The RRC Reconfiguration message may include a list of candidate cells, and the UE 404 may further send a RRC Reconfiguration Complete message back to source gNB. Further, the UE may perform measurement and initiate handover on the cell gNB2 which supports relaxed measurement. The handover shall be completed based on RRC configuration messages exchanged between the UE and the gNB2 which supports relaxed measurement.

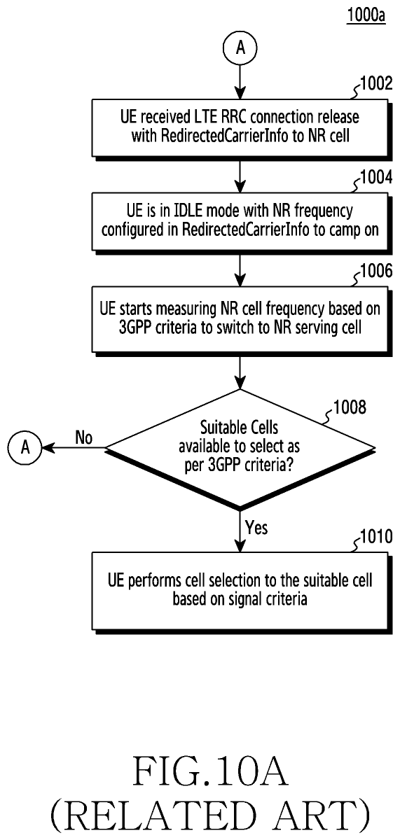

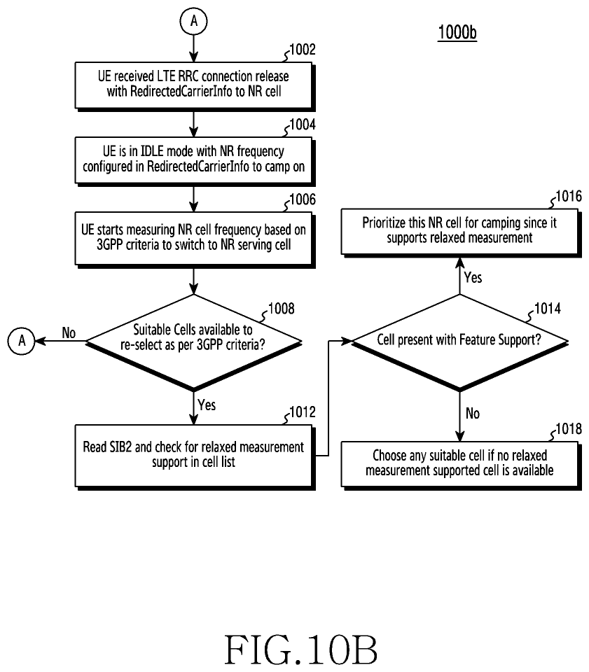

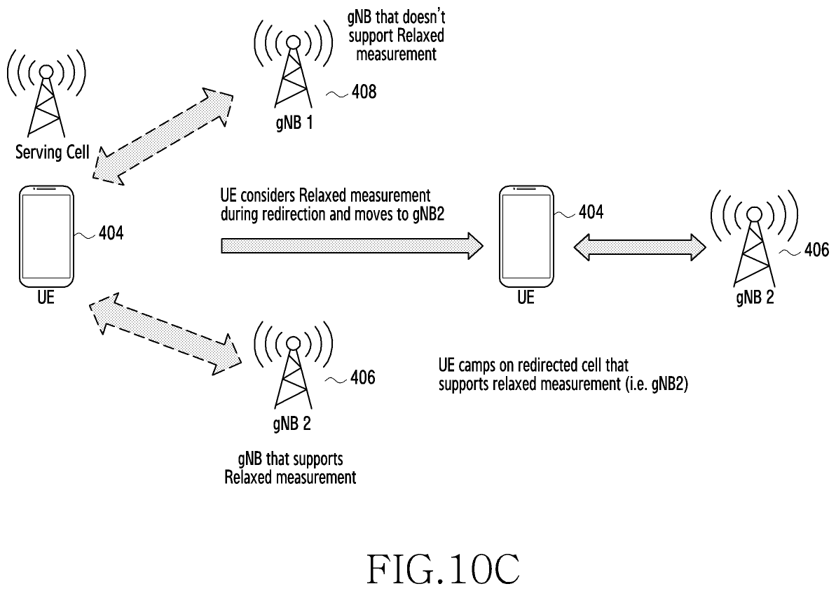

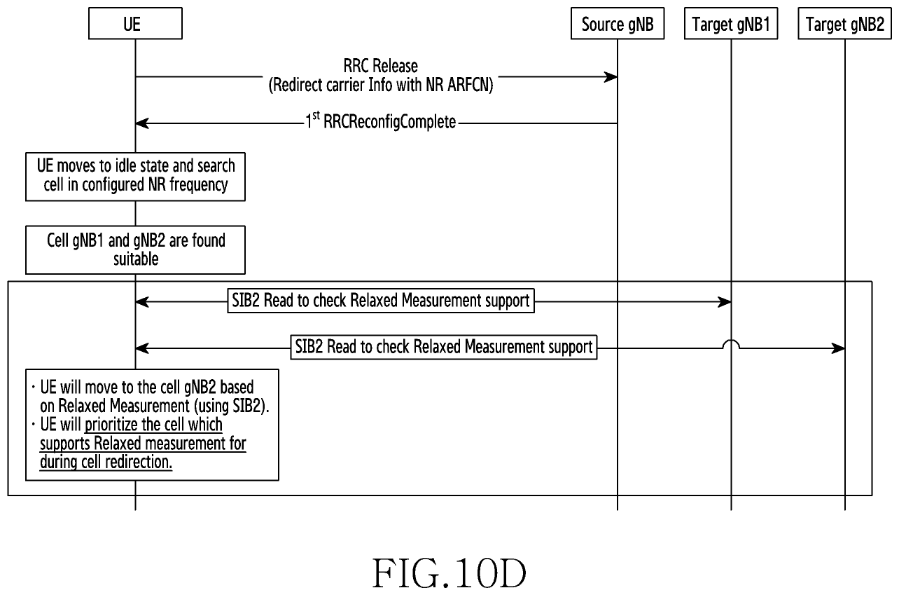

FIG. 10A is a flowchart illustrating a method 1000a for redirection in 5G NR at a UE, according to the prior art. As depicted, at 1002, the method 1000a comprises UE receiving LTE RRC connection release with RedirectedCarrierInfo to NR cell. Further, at 1004, the method 100a comprises UE being in IDLE mode with NR frequency configured in RedirectedCarrierInfo to camp on. At 1006, the method 1000a comprises performing measurement, by the UE, NR cell frequency based on 3GPP criteria to switch to such NR cell. At 1008, the method 1000a comprises determining whether one or more suitable cells are found for selection as per 3GPP criteria. If one or more suitable candidate cells are available for selection, then the selection/redirection may be performed based on signal criteria (e.g., RSRP/RSRQ/SINR) at 1010.

FIG. 10B is a flowchart illustrating an example method 1000b for prioritizing cells based on relaxed measurements during redirection, according to various embodiments. FIGS. 10C and 10D include a diagram and a signal flow diagram respectively illustrating an example of prioritizing cells based on relaxed measurements during redirection, according to various embodiments. The method 1000b includes operations 1002-1008 similar to the corresponding operations in method 1000a. According to an embodiment of the present disclosure, even after suitable cells are found for selection, a further operation 1012 comprising reading and analysis of SIB2 may be performed by the UE for relaxed measurement support in the cell(s). At 1014, the method 1000b comprises determining whether one or more cells support the relaxed measurement feature. If a cell is found with relaxed measurement support, then the UE 404 may be configured to prioritize such cell for camping at 1016. Otherwise, the selection/redirection may be performed based on signal strength at 1018.

Referring to FIGS. 10C and 10D, the UE 404 may be in RRC connected mode and may receive RRC connection release with RedirectedCarrierInfo from its associated source gNB. During redirection, UE scans the NR frequencies to identify the deployed NR cells and performs SSB decoding to check the cell suitability. As is widely known, the SSB decoding is used in 5G for cell synchronization. Using SSB decoding, the UE determines the cell ID, MIB, SIB1. Subsequently, the cell suitability check is performed. The cell suitability check is performed in accordance with section 5.2.3.2 of 3GPP specification TS 38.304. In conventional solutions, the UE camps on the detected suitable cell based on 5-criteria (e.g., based on RSRP and/or RSRQ values) and no other checks are performed by the UE. According to an embodiment of the present disclosure, when multiple cells are identified for the configured NR frequency in RedirectedCarrierInfo in RRC connection release, then UE 404 may prioritize the camping on the release-16 relaxed measurement feature supported cell.

During redirection, after checking the cell suitability criteria, the UE may read the SIB2 of the all the suitable cells to check the support of release-16 relaxed measurement feature. Based on the SIB2 information, the UE may identify which all cells support release-16 relaxed measurement feature. So, for camping during the redirection to NR frequency, UE will prioritize the cell which supports relaxed measurement feature. Thus, the UE may camp on the cell where it will consume lower power. For example, if UE found 2 suitable cells—gNb1 408 and gNB2 406 in the environment. The gNB1 408 may not support Release-16 Relaxed measurement feature, whereas gNB2 406 may support release-16 relaxed measurement. As per the current embodiment of the present disclosure, the UE 404 may read the SIB2 of gNB1 and gNB2 and identifies in which cell relaxed measurement is supported. Based on this determination, the UE may prioritize camping on gNB2 on the redirected frequency. Hence, the UE 404 may consume lesser power in gNB2 due to release-16 relaxed measurement feature support in gNB2 406.

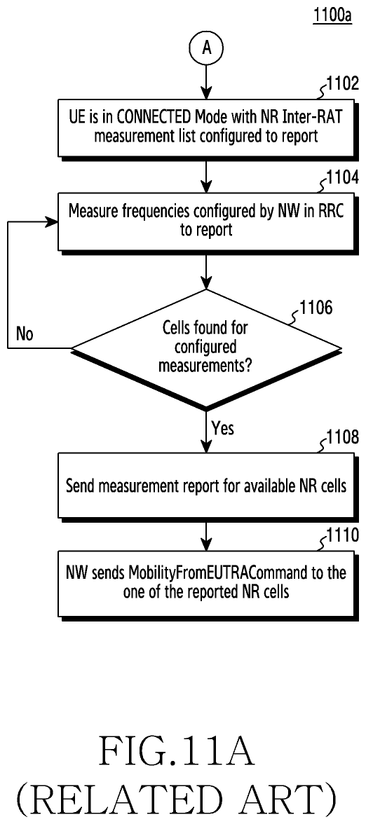

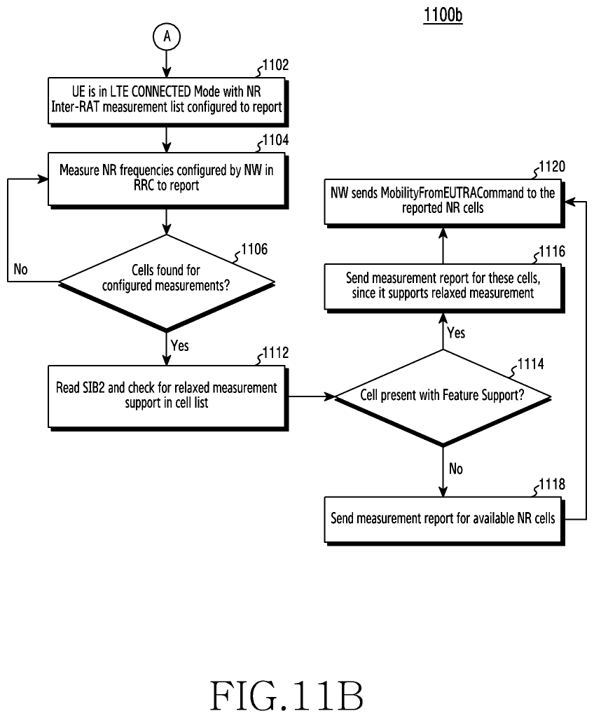

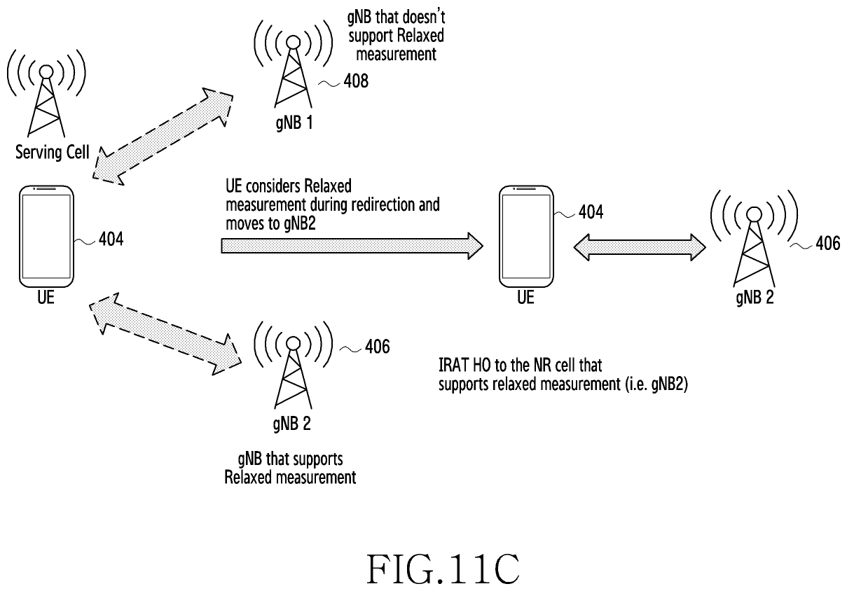

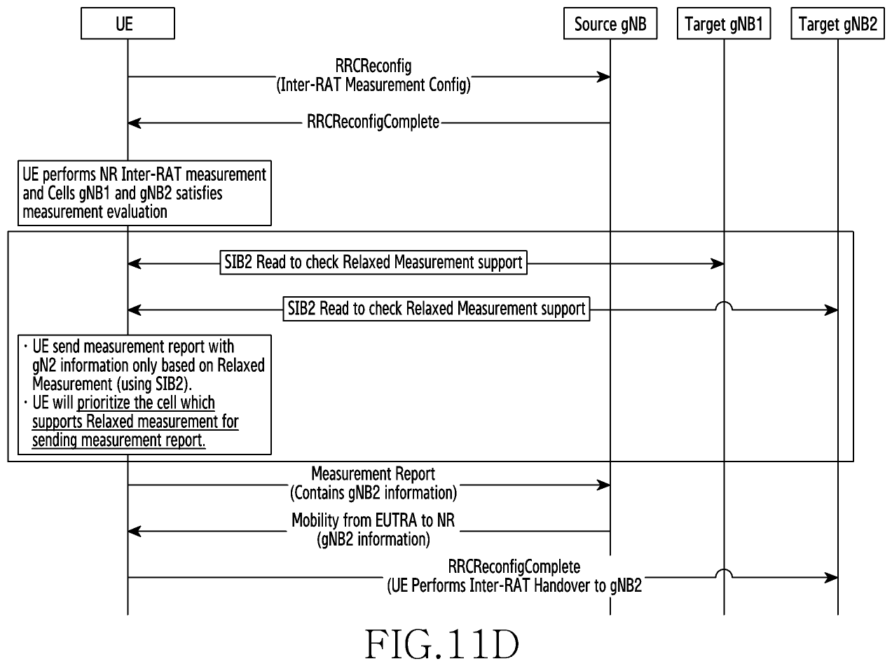

FIG. 11A is a flowchart illustrating a method for Inter-RAT handover in 5G NR at a UE, according to the prior art. As depicted, at 1102, the method 1100a comprises UE being in CONNECTED mode with NR Inter-RAT measurement list configured to report. Further, at 1104, the method 1100a comprises UE performing measurement of the NR cell frequencies which are configured by the network in the RRC message to report. At 1106, the method 1100a comprises determining whether one or more suitable cells are found for selection as per 3GPP criteria. If one or more suitable candidate cells are available, then the measurement report may be sent for all such available NR cells at 1108. In response, at 1110, the method 1100a may comprise the network sending a MobilityFromEUTRACommand to the one of the reported NR cells.

FIG. 11B is a flowchart illustrating an example method 1100b for prioritizing cells based on relaxed measurements during Inter-RAT handover, according to various embodiments. FIGS. 11C and 11D include a diagram and a signal flow diagram respectively illustrating an example of prioritizing cells based on relaxed measurements during Inter-RAT handover, according to various embodiments. The method 1100b includes operations 1102-1106 similar to the corresponding operations in method 1100a. According to an embodiment of the present disclosure, even after suitable cells are found for configured measurements, a further operation 1112 comprising reading and analysis of SIB2 may be performed by the UE for relaxed measurement support in the cell(s). At 1114, the method 1100b comprises determining whether one or more cells support the relaxed measurement feature. If a cell is found with relaxed measurement support, then the UE 404 may be configured to send measurement report for these cells only which support relaxed measurement at 1116. Otherwise, the measurement report may be sent for all available cells at 1118. In response, at 1120, the method 1100b may comprise the network sending a MobilityFromEUTRACommand to the one of the reported NR cells.

Referring to FIGS. 11C and 11D, the UE 404 may be in LTE RRC connected mode and the network may have configured UE with NR measurement objects for Inter-RAT handover. The UE 404 may measure the configured NR measurement objects to send the measurement report based on meeting of criteria of configured events (Event B1, e.g., Inter RAT neighbour becomes better than a predefined threshold) for handover. According to an embodiment, whenever there are more than one NR neighbour cells satisfying the Inter-RAT B1 event criteria for handover from LTE to NR, then UE 404 may prioritize the sending the report containing the release-16 relaxed measurement feature supported cell. After evaluation of B1 Event condition, the UE may be configured to read the SIB2 of the all the NR neighbour cells satisfying the event criteria to check the support of release-16 relaxed measurement feature. Based on the SIB2 information, the UE may identify which all cells support release-16 relaxed measurement feature.

So, for Inter-RAT handover, the UE may prioritize relaxed measurement supported cell in the measurement report. As a result, the network may configure the UE with NR cell that supports relaxed measurement as target cell. This will increase the chance of getting MobilityFromEUTRACommand to desired cell for lower power consumption.

For example, the UE may have found 2 neighbour cells—gNb 1 408 and gNB2 406 in the environment that satisfy the Event B1 event criteria. While the gNB1 408 does not support Release-16 Relaxed measurement feature, the gNB2 406 may support release-16 relaxed measurement. The UE 404 may read the SIB2 of gNB1 408 and gNB2 406 and identify in which cell relaxed measurement is supported. Based on this determination, the UE may prioritize reporting gNB2 406 in measurement report. As a result, the network configures the UE 404 with gNB2 406 in MobilityFromEUTRACommand as target cell. So, in the new target cell if UE moves to IDLE state after connection, UE will be able to avail relaxed measurement feature for power saving.

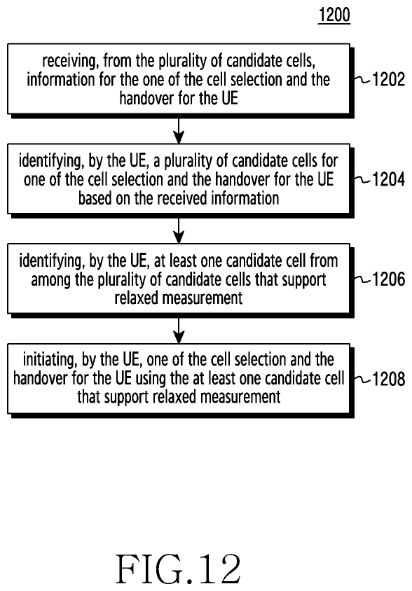

FIG. 12 is a flowchart illustrating an example method 1200 for initiating one of a cell selection and a handover for a User Equipment (UE), according to various embodiments. In an embodiment, the cell selection may include a cell selection and/or a cell re-selection, as discussed previously with respect to FIGS. 6A-6C and 7A-7C. Further, the handover may include a handover, a conditional handover, a DAPS handover, a redirection, and/or an Inter-RAT handover, as discussed previously with respect to FIGS. 8A-8D, 9A-9D, 10A-10D, and 11A-11D. As may be apparent to a person skilled in the art, FIGS. 12-14 include one or more operations as already discussed above with respect to cell selection and handovers in FIGS. 6A-6C, 7A-7C, 8A-8D, 9A-9D, 10A-10D, and 11A-11D.

At 1202, the method 1200 comprises receiving, from the plurality of candidate cells, information for the one of the cell selection and the handover for the UE. In an embodiment, the information may include an SIB2 element. Further, the information may be received from one or more gNBs in the environment surrounding the UE. Also, in an embodiment, the information may be received based on at least a broadcast message received from the one or more gNBs.

At 1204, the method 1200 comprises identifying, by the UE, a plurality of candidate cells for one of the cell selection and the handover for the UE based on the received information. In an embodiment, the method 1200 at step 1204 further comprises determining at least two candidate cells from among the plurality of candidate cells that support relaxed measurement. For example, a Reference Signal Received Power (RSRP) and a bandwidth of the at least two candidate cells may be compared to determine a selected candidate cell.

At 1206, the method 1200 comprises identifying, by the UE, at least one candidate cell from among the plurality of candidate cells that support relaxed measurement. The at least one candidate cell may be identified based on a relaxed measurement parameter identified in the SIB2 IE of the received information.

In an embodiment, the method 1200 at 1206 may include determining whether the information comprises at least one relaxed measurement parameter for each of the plurality of candidate cells, wherein the at least one relaxed measurement parameter indicates a relaxation method for a cell measurement in the corresponding candidate cell of the plurality of candidate cells. Further, the at least one candidate cell may be identified by the UE that support relaxed measurement based on a determination that the information comprises the at least one relaxed measurement parameter for each of the at least one candidate cell. In an example embodiment, the at least one relaxed measurement parameter for a candidate cell may indicate support for relaxation of frequency measurements in one of an idle and inactive state of the UE, when the UE is served by the candidate cell.

For example, at 1206, the method 1200 comprises determining whether the information comprises the at least one relaxed measurement parameter within an Information Element (IE) of a System Information Block 2 (SIB2), broadcasted by the network in each of the plurality of candidate cells for one of the cell selection and the handover, wherein the SIB2 is received by the UE during one of a cell selection/reselection, a conditional handover, a Dual Active Protocol Stack (DAPS) handover, redirection, and mobility to New Radio (NR) from Evolved Universal Terrestrial Radio Access (EUTRA).

At 1208, the method 1200 comprises initiating, by the UE, one of the cell selection and the handover for the UE using the at least one candidate cell that support relaxed measurement. In an embodiment, the initiation of one of the cell selection and the handover for the UE using the at least one candidate cell that support relaxed measurement comprises selecting the at least one candidate cell for camping on, in response to a determination that the UE needs to initiate the cell selection; and sending measurement report for the at least one candidate cell in response to a determination that the UE needs to initiate the handover.

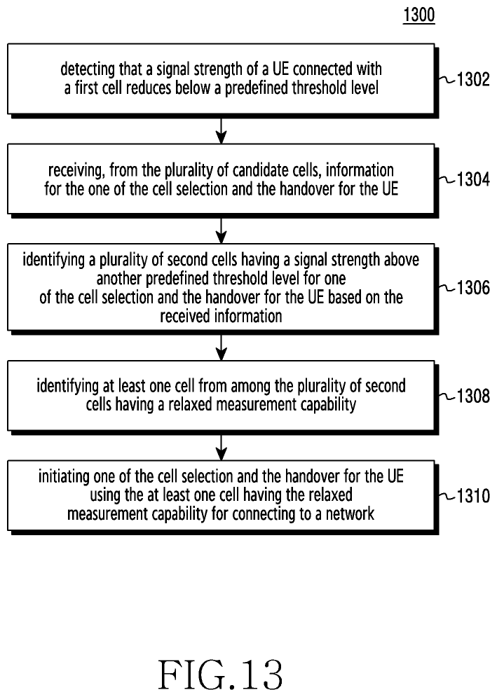

FIG. 13 is a flowchart illustrating an example method 1300 for initiating one of a cell selection and a handover for a User Equipment (UE), according to various embodiments. In an embodiment, the cell selection may include a cell selection and/or a cell re-selection, as discussed previously with respect to FIGS. 6A-6C and 7A-7C. Further, the handover may include a handover, a conditional handover, a DAPS handover, a redirection, and/or an Inter-RAT handover, as discussed previously with respect to FIGS. 8A-8D, 9A-9D, 10A-10D, and 11A-11D. As may be apparent to a person skilled in the art, FIGS. 12-14 include one or more operations as already discussed above with respect to cell selection and handovers in FIGS. 6A-6C, 7A-7C, 8A-8D, 9A-9D, 10A-10D, 11A-11D as well as FIG. 12. Thus, for the sake of brevity, these operations are not discussed here in detail. Some of the operations of FIG. 13 may be a part of operations of FIG. 12.

At 1302, the method 1300 comprises detecting that a signal strength of a UE connected with a first cell reduces below a predefined threshold level.

At 1304, the method 1300 comprises receiving, from the plurality of candidate cells, information for the one of the cell selection and the handover for the UE.

At 1306, the method 1300 comprises identifying a plurality of second cells having a signal strength above another predefined threshold level for one of the cell selection and the handover for the UE based on the received information.

At 1308, the method 1300 comprises identifying at least one cell from among the plurality of second cells having a relaxed measurement capability.

At 1310, the method 1300 comprises initiating one of the cell selection and the handover for the UE using the at least one cell having the relaxed measurement capability for connecting to a network.

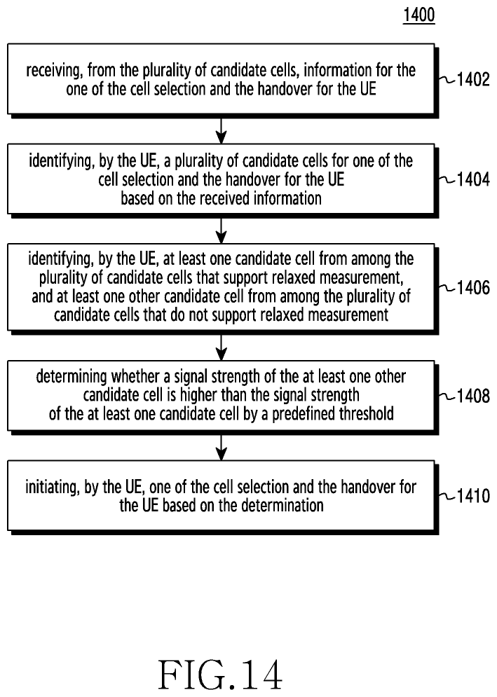

FIG. 14 is a flowchart illustrating an example method 1400 for initiating one of a cell selection and a handover for a User Equipment (UE), according to various embodiments. In an embodiment, the cell selection may include a cell selection and/or a cell re-selection, as discussed previously with respect to FIGS. 6A-6C and 7A-7C. Further, the handover may include a handover, a conditional handover, a DAPS handover, a redirection, and/or an Inter-RAT handover, as discussed previously with respect to FIGS. 8A-8D, 9A-9D, 10A-10D, and 11A-11D. As may be apparent to a person skilled in the art, FIGS. 12-14 include one or more operations as already discussed above with respect to cell selection and handovers in FIGS. 6A-6C, 7A-7C, 8A-8D, 9A-9D, 10A-10D, 11A-11D as well as FIGS. 12 and 13. Thus, for the sake of brevity, these operations are not discussed here in detail.

At 1402, the method 1400 comprises receiving, from the plurality of candidate cells, information for the one of the cell selection and the handover for the UE. In an embodiment, receiving the information comprises receiving information comprising at least one relaxed measurement parameter within an Information Element (IE) of a System Information Block 2 (SIB2), broadcasted by the network in each of the plurality of candidate cells for one of the cell selection and the handover.

At 1404, the method 1400 comprises identifying, by the UE, a plurality of candidate cells for one of the cell selection and the handover for the UE based on the received information.

At 1406, the method 1400 comprises identifying, by the UE, at least one candidate cell from among the plurality of candidate cells that support relaxed measurement, and at least one other candidate cell from among the plurality of candidate cells that do not support relaxed measurement.

At 1408, the method 1400 comprises determining whether a signal strength of the at least one other candidate cell is higher than the signal strength of the at least one candidate cell by a predefined threshold. In an embodiment, the predefined threshold may correspond to 0.7*RSRP+0.3*RM (relaxed measurement enablement) for prioritization of a candidate cell. In an embodiment, the prioritization of a candidate cell is determined based on a combination of signal strength and the relaxed measurement criteria.

At 1410, the method 1400 comprises initiating, by the UE, one of the cell selection and the handover for the UE based on the determination. In an embodiment, the initiating one of the cell selection and the handover for the UE using the at least one candidate cell that support relaxed measurement comprises: selecting the at least one candidate cell for camping on, in response to a determination that the UE needs to initiate the cell selection; and sending measurement report for the at least one candidate cell in response to a determination that the UE needs to initiate the handover.

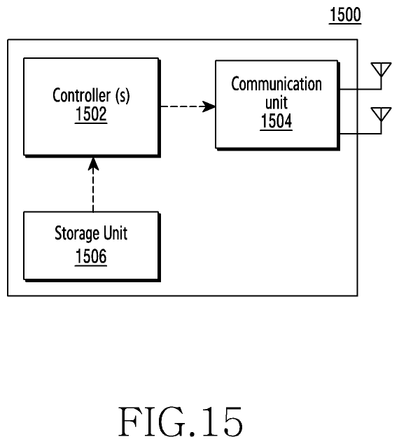

FIG. 15 is a block diagram illustrating an example configuration of a user equipment (UE) 1500 in a wireless communication system, according to various embodiments. The configuration of FIG. 7 may be understood as a part of the configuration of the UE as discussed throughout this disclosure. Hereinafter, it is understood that terms including “unit” or “module” at the end may refer to the unit for processing at least one function or operation and may be implemented in hardware, software, or a combination of hardware and software.

Referring to FIG. 15, the UE 1500 may correspond to a system 1500 comprising at least one controller or processor (e.g., including control or processing circuitry) 1502, a communication unit (e.g., including communication circuitry) 1504 (e.g., communicator or communication interface), and a storage unit (e.g., including a memory) 1506 (e.g., storage). By way of example, the UE 1500 may be a User Equipment, such as a cellular phone or other device that communicates over a plurality of cellular networks (such as a 3G, 4G, a 5G or pre-5G, 6G network or any wireless communication network such as 802.11 based Wi-Fi networks). The communication unit 1504 may include various communication circuitry and perform functions for transmitting and receiving signals via a wireless channel.

As an example, the controller 1502 may be a single processing unit or a number of units, all of which could include multiple computing units. The controller 1502 may be implemented as one or more microprocessors, microcomputers, microcontrollers, digital signal processors, central processing units, state machines, logic circuitries, and/or any devices that manipulate signals based on operational instructions. Among other capabilities, the controller 1502 is configured to fetch and execute computer-readable instructions and data stored in the memory. The controller 1502 may include one or a plurality of processors. At this time, one or a plurality of controller 1502 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of controllers 1502 may control the processing of the input data in accordance with a predefined operating rule or artificial intelligence (AI) model stored in the non-volatile memory and the volatile memory, e.g., memory unit 1504. The predefined operating rule or artificial intelligence model is provided through training or learning.

The memory 1504 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The controller 1502 may include one or more modules which are configured to perform one or more functions discussed herein, such as determination of cross-domain parameters, determination of confidence value, re-scan trigger, etc. for the purpose of determining a suitable network for connection.

In the conventional solutions, the UE may reselect or move to a cell where release-16 relaxed measurement support is not present. This will lead to higher power consumption due to measurement which could have been avoided if UE would have moved to relaxed measurement supported cell. Advantageously, the present disclosure facilitates relaxed measurement in UEs. For example, the disclosure facilitates in enabling UEs to reduce the measurement frequency, when it is in low mobility and not in cell edge to save power. Accordingly, the disclosure ensures that the UEs are able to avail the power saving measures of relax measurement whenever possible in different scenarios. Additionally, the present disclosure provides embodiments which help UEs to prioritize NR cells that supports relaxed measurements based on relaxedMeasurement-r16 IE broadcasted in SIB2 message during cell selection/reselection/redirection in RRC idle or inactive state and during Inter-RAT Handover, DAPS handover and conditional handover in RRC Connected state. This provision facilitates that UEs are able to avail the power saving measures of relax measurement whenever possible in different scenarios.

Further, the disclosure is useful for the UEs to make a quick decision to select the cell based on efficient and desired result to the end user on power optimization and mobility performance. Moreover, with the disclosure, low power consumption is achieved, and the power optimization is utilized and so, the user would realize enhanced battery performance and enhanced result will be achieved. Additionally, with the disclosure, users would get high mobility performance and enrich in mobile service continuity, and so user end experience would be higher.

While the disclosure has been illustrated and described with reference to various example embodiments, it will be understood that the various example embodiments are intended to be illustrative, not limiting. As would be apparent to a person in the art, various working modifications may be made to the disclosure without departing from the full scope of the disclosure, including the appended claims and their equivalents. Those skilled in the art will appreciate that one or more of the described elements may well be combined into a single functional element. Alternatively, certain elements may be split into multiple functional elements. Elements from an embodiment may be added to another embodiment.

What is claimed is:

1. A method for initiating one of a cell selection and a handover for a User Equipment (UE), the method comprising:
identifying, by the UE, a plurality of candidate cells for one of the cell selection and the handover for the UE;
identifying, by the UE, at least one candidate cell from among the plurality of candidate cells that support relaxed measurement; and
initiating, by the UE, one of the cell selection and the handover for the UE using the at least one candidate cell that support relaxed measurement.

2. The method as claimed in claim 1, further comprising:
receiving, from the plurality of candidate cells, information for the one of the cell selection and the handover for the UE,
wherein the identifying the plurality of candidate cells comprises identifying, by the UE, the plurality of candidate cells for one of the cell selection and the handover for the UE based on the received information.

3. The method as claimed in claim 2, wherein the receiving comprises receiving information comprising at least one relaxed measurement parameter within an Information Element (IE) of a System Information Block 2, broadcasted by the network in each of the plurality of candidate cells for one of the cell selection and the handover.

4. The method as claimed in claim 2, further comprising:
determining whether the information comprises at least one relaxed measurement parameter for each of the plurality of candidate cells, wherein the at least one relaxed measurement parameter indicates a relaxation method for a cell measurement in the corresponding candidate cell of the plurality of candidate cells; and
wherein identifying the at least one candidate cell comprises identifying, by the UE, the at least one candidate cell that supports relaxed measurement based on a determination that the information comprises the at least one relaxed measurement parameter for each of the at least one candidate cell.

5. The method as claimed in claim 4, further comprising:
determining whether the information comprises the at least one relaxed measurement parameter within an Information Element (IE) of a System Information Block 2 (SIB2), broadcasted by the network in each of the plurality of candidate cells for one of the cell selection and the handover, wherein the SIB2 is received by the UE during one of a cell selection/reselection, a conditional handover, a Dual Active Protocol Stack (DAPS) handover, redirection, and mobility to New Radio (NR) from Evolved Universal Terrestrial Radio Access (EUTRA).

6. The method as claimed in claim 4, wherein the at least one relaxed measurement parameter for a candidate cell indicates support for relaxation of frequency measurements in one of an idle and inactive state of the UE, based on the UE being served by the candidate cell.

7. The method as claimed in claim 1, wherein initiating one of the cell selection and the handover for the UE using the at least one candidate cell that support relaxed measurement comprises:
selecting the at least one candidate cell for camping on, in response to a determination that the UE needs to initiate the cell selection; and
sending measurement report for the at least one candidate cell in response to a determination that the UE needs to initiate the handover.

8. The method as claimed in claim 1, wherein initiating one of the cell selection and the handover comprises:
determining at least two candidate cells from among the plurality of candidate cells that support relaxed measurement;
comparing a Reference Signal Received Power (RSRP) and a bandwidth of the at least two candidate cells to determine a selected candidate cell with a higher RSRP and the bandwidth; and
initiating, by the UE, one of the cell selection and the handover for the UE using the selected candidate cell.

9. The method as claimed in claim 1, further comprising:
detecting that a signal strength of a UE connected with a first cell is reduced below a specified threshold level; and
identifying the plurality of candidate cells having a signal strength above another specified threshold level in response to detecting that the signal strength of the UE connected with the first cell decreases below the specified threshold level.

10. A method for initiating one of a cell selection and a handover for a User Equipment (UE), the method comprising:
identifying, by the UE, a plurality of candidate cells for one of the cell selection and the handover for the UE;
identifying, by the UE, at least one candidate cell from among the plurality of candidate cells that support relaxed measurement, and at least one other candidate cell from among the plurality of candidate cells that do not support relaxed measurement;
determining whether a signal strength of the at least one other candidate cell is higher than the signal strength of the at least one candidate cell by a specified threshold; and
initiating, by the UE, one of the cell selection and the handover for the UE based on the determination.

11. The method as claimed in claim 10, further comprising:
receiving, from the plurality of candidate cells, information for the one of the cell selection and the handover for the UE,
wherein identifying the plurality of candidate cells comprises identifying, by the UE, the plurality of candidate cells for one of the cell selection and the handover for the UE based on the received information.

12. The method as claimed in claim 11, wherein the receiving comprises receiving the information comprising at least one relaxed measurement parameter within an Information Element (IE) of a System Information Block 2 (SIB2), broadcasted by the network in each of the plurality of candidate cells for one of the cell selection and the handover.

13. The method as claimed in claim 10, wherein initiating one of the cell selection and the handover for the UE using the at least one candidate cell that support relaxed measurement comprises:
selecting the at least one candidate cell for camping on, in response to a determination that the UE needs to initiate the cell selection; and
sending measurement report for the at least one candidate cell in response to a determination that the UE needs to initiate the handover.

14. A system configured to initiate one of a cell selection and a handover for a User Equipment (UE), the system comprising:
one or more processors configured to:
identify, by the UE, a plurality of candidate cells for one of the cell selection and the handover for the UE;
identify, by the UE, at least one candidate cell from among the plurality of candidate cells that support relaxed measurement; and
initiate, by the UE, one of the cell selection and the handover for the UE using the at least one candidate cell that support relaxed measurement.

15. The system as claimed in claim 14, wherein the one or more processors are configured to:
receive, from the plurality of candidate cells, information for the one of the cell selection and the handover for the UE; and
identify, by the UE, the plurality of candidate cells for one of the cell selection and the handover for the UE based on the received information.

16. The system as claimed in claim 15, wherein the one or more processors are further configured to receive the information comprising at least one relaxed measurement parameter within an Information Element (IE) of a System Information Block 2 (SIB2), broadcasted by the network in each of the plurality of candidate cells for one of the cell selection and the handover.

17. The system as claimed in claim 15, wherein the one or more processors are further configured to:
determine whether the information comprises at least one relaxed measurement parameter for each of the plurality of candidate cells, wherein the at least one relaxed measurement parameter indicates that a relaxation method for a cell measurement in the corresponding candidate cell of the plurality of candidate cells; and
identify, by the UE, the at least one candidate cell that support relaxed measurement based on a determination that the information comprises the at least one relaxed measurement parameter for each of the at least one candidate cell.

18. The system as claimed in claim 17, wherein the one or more processors are further configured to determine whether the information comprises the at least one relaxed measurement parameter within an Information Element (IE) of a System Information Block 2 (SIB2), broadcasted by the network in each of the plurality of candidate cells for one of the cell selection and the handover, wherein the SIB2 is received by the UE during one of a cell selection/reselection, a conditional handover, a Dual Active Protocol Stack (DAPS) handover, redirection, and mobility to New Radio (NR) from Evolved Universal Terrestrial Radio Access (EUTRA).

19. The system as claimed in claim 17, wherein the at least one relaxed measurement parameter for a candidate cell indicates support for relaxation of frequency measurements in one of an idle and inactive state of the UE, based on the UE being served by the candidate cell.

20. The system as claimed in claim 14, wherein to initiate one of the cell selection and the handover for the UE using the at least one candidate cell that support relaxed measurement, the one or more processors are configured to:
select the at least one candidate cell for camping on, in response to a determination that the UE needs to initiate the cell selection; and
send measurement report for the at least one candidate cell in response to a determination that the UE needs to initiate the handover.
